(19) United States
(12) Patent Application Publication
(10) Pub. No.: US 2006/0287059 A1
(43) Pub. Date: Dec. 21, 2006

(54) Gaming machine

(75) Inventor: Kazuo Okada, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/365,804

(22) Filed: Mar. 2, 2006

(30) Foreign Application Priority Data
May 30, 2005 (JP) 2005-157191
May 30, 2005 (JP) 2005-157192

(51) Int. Cl. A63F 13/00

(52) U.S. Cl. 463/20

(57) ABSTRACT

A lottery value defining unit included in a pachi-slot machine is performed to make a first number range according to a first internal win different from a second number range according to a second internal win that is different from the first internal win. Furthermore, the lottery value defining unit is performed to make a third number range according to a third internal win, which is different from the first and second internal wins, at least partially overlapped with the first and second number ranges. The overlapped ranges of the first and second number ranges with the third number range are different from each other.

### CROSS REFERENCE TO RELATED APPLICATION

This application is based upon and claims the benefit of priority from the prior Japanese Patent Applications No. 2005-157191, filed on May 30, 2005, and No. 2005-157192, filed on May 30, 2005, the entire contents of which are incorporated herein by reference.

### BACKGROUND OF THE INVENTION

1. Field of the Invention

The present invention relates to a gaming machine that determines an internal win by lottery among internal wins, based on the detection of a start operation by a player.

2. Description of Related Art

As one of the gaming machines, there is a pachi-slot machine in which the rotation of a reel is stopped by a player's operation. Generally in the pachi-slot machine, when a start lever is manipulated after the insertion of a medal of a game value into a medal slot, an internal win is determined by lottery and reels starts to rotate. When a stop button is manipulated after the respective reels reach a certain speed, a reel corresponding to the manipulation of the stop button stop the rotation. When all the reels stop rotating, if a symbol combination corresponding to the internal win determined by lottery is lined up all together, a medal as a game value is paid out to a player.

In a pachi-slot machine disclosed in Japanese Patent Unexamined Publication No. 2002-78857 (See sections [0093] to [0098], and FIGS. 15 and 16), the lottery for determining an internal win is performed by a random number lottery using a probability lottery table. On the probability lottery table, a different number range is sequentially allocated to each internal win from a predetermined range of the random number. In the random number lottery, an upper limit value of the number range sequentially allocated to each internal win is subtracted from an extracted random number, and if the result of the subtraction indicates a negative value, it is determined an internal win allocated to that number range as that of the corresponding unit game. Meanwhile, if the result of the subtraction is a positive value, the same process is performed for an upper limit value assigned to a next internal win, until the subtraction result becomes a negative value.

### SUMMARY OF THE INVENTION

However, in the pachi-slot machine disclosed in the document, a calculation of the subtraction of the upper limit value of the number range sequentially allocated to each internal win from the extracted random number is sequentially performed for each upper limit value of the respective number ranges, and when the calculation value is negative, the lottery of the internal win is terminated. Therefore, an internal win determined by extraction of one random number is limited to a single type. This is fixedly conceptualized to the players and it is required a new lottery manner for an internal win.

In addition, since the determination of the internal win is directly linked with incomings and outgoings of a game arcade equipped with a pachi-slot machine, the improvement of a security therefrom is a matter of the utmost concern to the game arcade. In the conventional pachi-slot machine described above, since an internal win is determined based on only what the extracted random number is below the upper limit value of the number range, the number range allocated to the internal win according to a prize with a payout leans toward the smaller number. Accordingly, in case that a start operation is repeated at a certain timing by means of unfair practice, the random number in the leaning-side number range is continuously extracted, so that an internal win corresponding to winning is continuously determined in higher probability than an originally predetermined value, thereby providing a player with a greater game value, which causes a problem of worsening the business administration of the game arcade equipped with the pachi-slot machine.

An object of the present invention is to provide a gaming machine that offers a new lottery manner for an internal win to entertain a player with a new pleasure through defeat of the player's fixed idea as well as to enable to consider an effective counterplan for unfair practice, thereby satisfying the request from both a player and a game arcade.

According to a first aspect of the present invention, there is provided a gaming machine comprising: a symbol display unit for displaying a plurality of symbols; a start operation detector for detecting a start operation by a player; a random number sampling unit for sampling a random number from a predetermined number range, based on the detection of the start operation performed by the start operation detector; a lottery value defining unit for defining an upper limit value and a lower limit value of a number range within the predetermined number range in accordance with an internal win; a random number determining unit for determining whether or not the random number sampled by the random number sampling unit is within the number range, through comparing the value of the random number sampled by the random number sampling unit with both the upper and lower limit values; an internal win determining unit for determining an internal win according to the number range when the random number determining unit determines that the random number sampled by the random number sampling unit is within the number range; a variable display control unit for controlling the symbol display unit to variably display the symbols, based on the detection of the start operation by the start operation detector; a stop operation detector for detecting a stop operation by a player; a stop control unit for controlling the stop of the variable display controlled by the variable display control unit, based on the detection of the stop operation by the stop operation detector and an internal win determined by the internal win determining unit; and a game value offering unit for offering a game value when a predetermined symbol combination is displayed in a stop mode by the symbol display unit through the stop control by the stop control unit, wherein the lottery value defining unit is performed to make a first number range according to a first internal win different from a second number range according to a second internal win that is different from the first internal win, and to make a third number range according to a third internal win, which is different from the first and second internal wins, at least partially overlapped with the first and second number ranges, wherein the overlapped ranges of the first and second number ranges with the third number range are different from each other.

According to a second aspect of the present invention, there is provided a gaming machine comprising: a symbol display unit for displaying a plurality of symbols; a start operation detector for detecting a start operation by a player; a random number sampling unit for sampling a random number from a predetermined number range, based on the detection of the start operation performed by the start operation detector; a lottery value defining unit for defining an upper limit value and a lower limit value of a number range within the predetermined number range in accordance with an internal win; a random number determining unit for determining whether or not the random number sampled by the random number sampling unit is within the number range, through comparing the value of the random number sampled by the random number sampling unit with both the upper and lower limit values; an internal win determining unit for determining an internal win according to the number range when the random number determining unit determines that the random number sampled by the random number sampling unit is within the number range; a variable display control unit for controlling the he symbol display unit to variably display the symbols, based on the detection of the start operation by the start operation detector; a stop operation detector for detecting a stop operation by a player; a stop control unit for controlling the stop of the variable display controlled by the variable display control unit, based on the detection of the stop operation by the stop operation detector and an internal win determined by the internal win determining unit; a game value offering unit for offering a game value when a predetermined symbol combination is displayed in a stop mode by the symbol display unit through the stop control by the stop control unit; and a setting value selector for selecting a setting value of a ball payout rate indicative of a ratio of total game value offered to a player by the game value offering unit to the total game value to be betted, among a plurality of predetermined values; wherein the lottery value defining unit is performed to make the number range according to any one of internal wins and the number according to other internal win, which is different from the one internal win, at least partially overlapped within the range according to the setting value selected by the setting value selector.

In the first aspect, since it is defined that the first number range according to the first internal win and the second number range according to the second internal win are at least partially overlapped with the third number range according to the third internal win, when the random number sampled by the random number sampling unit is within these overlapped number ranges, it is determined the internal wins of the first or second internal win and the third internal win according to the respective number ranges. Further, in the second aspect, since it is defined that the number range according to any one of the internal wins and the number range according to other internal win different from the one internal win are at least partially overlapped with each other, when the random number sampled by the random number sampling unit is within the overlapped number range, it is determined the internal wins of any one of the internal wins and other internal win according to the respective number ranges. Accordingly, in the first and second aspects, it is provided a new lottery manner for an internal win, capable of determining internal wins at once, using only a single random number and single lottery value defining unit. In addition, since it does not need to provide the lottery value defining unit for each internal win determined, there is no need to increase hardware resources.

Furthermore, in the first aspect, since the overlapped ranges of the first and second number ranges with the third number range are different from each other, upon display of a symbol combination corresponding to the first internal win in stop mode by the symbol display unit, the amount of player's expectation for the determination of the third internal win at the same time, and upon display of a symbol combination corresponding to the second internal win in stop mode by the symbol display unit, the amount of player's expectation for the determination of the third internal win at the same time can be made different.

Furthermore, in the second aspect, since the overlapped range of the number range according to any one of internal wins and the number range according to the internal win different from the one internal win is different according to the selected setting value, the probability of determining the one internal win and other internal win at the same time is different according to the selected setting value. Accordingly, when any one of the one internal win and the other win is selected, a player checks a ratio at which the other internal win is determined at the same time, thereby determining the selected setting value.

In addition, in the first and second aspects, since the number ranges allocated to the respective internal wins have the upper and lower limit values, they are not necessarily provided in order so that it is possible to irregularly provide the respective number ranges through overlapping or dispersing. Accordingly, it is prevented the sampled random number from continuously belonging within a number range according to an internal win concerning the winning even in the case of repetition of the start operation at a certain timing by an unfair practice. Therefore, since there is no case where the internal win concerning the winning is continuously determined in higher probability than predetermined one, it is prevented a game arcade equipped with a gaming machine from being worsened in its business administration.

As a result, there is provided a new lottery manner for an internal win to entertain a player with a new pleasure through defeat of the player's fixed idea as well as to enable to consider an effective counterplan for unfair practice, thereby satisfying the request from both a player and a game arcade.

### BRIEF DESCRIPTION OF THE DRAWINGS

Other and further objects, features and advantages of the invention will appear more fully from the following description taken in connection with the accompanying drawings, in which:

FIG. 1 is a front view illustrating an appearance of a pachi-slot machine according to an embodiment of the present invention;

FIG. 2 is a perspective view of an appearance of a reel unit included in a pachi-slot machine according to an embodiment of the present invention;

FIG. 3A is an exploded perspective view of the respective reel elements included in the reel unit shown in FIG. 2;

FIG. 3B is an exploded perspective view of a reel back lamp provided on the reel shown in FIG. 3A;

FIG. 4 is a view showing symbol rows depicted on an outer periphery of the reel shown in FIG. 3A;

FIG. 5 is a block diagram showing a circuit construction of a main control board of a pachi-slot machine according to an embodiment of the present invention;

FIG. 6 is a block diagram showing a circuit construction of a sub control board of a pachi-slot machine according to an embodiment of the present invention;

FIG. 7 is a conceptive diagram of a symbol combination table used in an embodiment of the present invention;

FIG. 8 is a conceptive diagram of an internal lottery determination table used in an embodiment of the present invention;

FIG. 9 is a conceptive diagram of an internal lottery table used in an embodiment of the present invention;

FIG. 10 is a conceptive diagram of an internal win determination table used in an embodiment of the present invention;

FIG. 11 is a conceptive diagram of a stop table determination table used in an embodiment of the present invention;

FIG. 12 is a conceptive diagram of an attraction-in priority table used in an embodiment of the present invention;

FIG. 13 is a conceptive diagram of a table upon the operation of RB used in an embodiment of the present invention;

FIG. 14 is a conceptive diagram of a table upon the operation of BB used in an embodiment of the present invention;

FIG. 15 is a conceptive diagram of an internal win 1 storage area used in an embodiment of the present invention;

FIG. 16 is a conceptive diagram of an internal win 2 storage area used in an embodiment of the present invention;

FIG. 17 is a conceptive diagram of a carryover win storage area used in an embodiment of the present invention;

FIG. 18 is a conceptive diagram of a storage area of select counter for stop used in an embodiment of the present invention;

FIG. 19 is a conceptive diagram of a random number storage area used in an embodiment of the present invention;

FIG. 20 is a flow chart of a schematic gaming process by a main CPU of a pachi-clot machine according to an embodiment of the present invention;

FIG. 21 is a flow chart of a schematic bonus operation monitoring process illustrated in FIG. 20;

FIG. 22 is a flow chart of a schematic medal receipt and start check process illustrated in FIG. 20;

FIG. 23 is a flow chart of a schematic game mode monitoring process illustrated in FIG. 20;

FIG. 24 is a first flow chart of a schematic internal lottery process illustrated in FIG. 20;

FIG. 25 is a second flow chart of a schematic internal lottery process illustrated in FIG. 20;

FIG. 26 is a flow chart of a schematic reel stop initial setting process illustrated in FIG. 20;

FIG. 27 is a flow chart of a schematic reel stop control process illustrated in FIG. 20;

FIG. 28 is a flow chart of a schematic display win searching process illustrated in FIG. 20;

FIG. 29 is a flow chart of a schematic bonus termination checking process illustrated in FIG. 20; and

FIG. 30 is a flow chart of a schematic bonus operation checking process illustrated in FIG. 20.

### DESCRIPTION OF THE PREFERRED EMBODIMENTS

Hereinafter, preferred embodiments of the invention will be described with reference to the drawings.

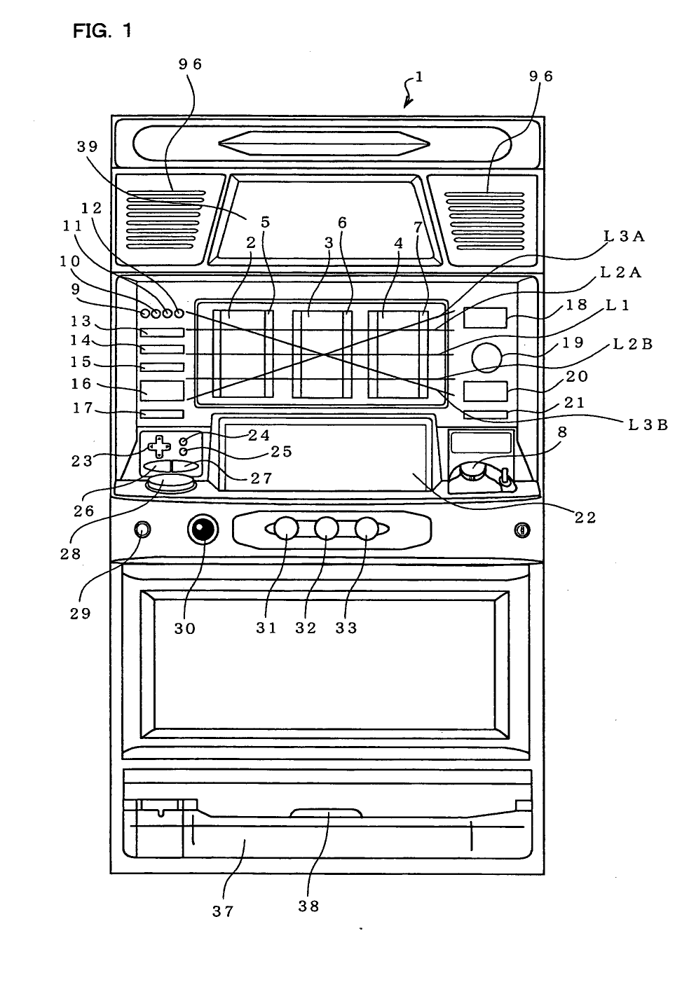

FIG. 1 is a front view of an appearance of a pachi-slot machine 1 according to a preferred embodiment of the present invention.

The pachi-slot machine 1 includes three rotatable reels 2 to 4 at the center of the main body thereof. The symbol rows consisting of various types of symbols are depicted on the outer peripheries of the reels 2 to 4. Three symbols can be seen through each display window 5 to 7 in front of the pachi-slot machine 1. Total five pay lines L1, L2A, L2B, L3A, and L3B consisting of three horizontal pay lines and two diagonal pay lines are formed on the display windows 5 to 7. A medal insertion slot 8 into which a medal of a game value is inserted is provided on the lower right side of the display windows 5 to 7. The reels 2 to 4 and the display windows 5 to 7 function as a symbol display unit for displaying symbols.

Before the start of a game, when a player inserts a medal into the medal insertion slot 8, one horizontal center pay line L1 becomes activated. When two medals are to be inserted, two of upper and lower horizontal pay lines are added thereto so that total three horizontal pay lines L1, L2A, and L2B become activated. When three medals are to be inserted, two of diagonal pay lines L3A and L3B are added thereto so that total five pay lines L1, L2A, L2B, L3A, and L3B become activated. The pay line that becomes activated will hereinafter be referred to as an activated line.

On the left side of the display window 5 to 7, the gaming operation display units 9 to 12, the BET lamps 13 to 15, a credit number display unit 16, and a start lamp 17 are provided. The respective display units 9 to 12 and the BET lamps 13 to 15 are light-controlled according to a game mode so that a player is informed of the game mode at that time. The credit number display unit 16 consists of three digits of 7-segment LEDs and displays the number of the medals presently credited in a medal counter in the machine. The start lamp 17 flickers when the respective reels 2 to 4 are able to operate.

On the right side of the display windows 5 to 7, a bonus count display unit 18, a WIN lamp 19, a payout number display unit 20, and an insert lamp 21 are provided serially in order from the upper side. The bonus count display unit 18 consists of three digits of 7-segment LEDs and digitally displays the remaining possible winning-number of an RB game upon the operation of a bonus game. The WIN lamp 19 is lightened when the symbols corresponding to the operation of the bonus are matched with the activated lines. The payout number display unit 20 consists of three digits of 7-segment LEDs and displays the medal payout number by winning. The insert lamp 21 is lightened when the medal can be inserted into the medal insertion slot 8.

A liquid crystal display device 22 is provided directly below the display windows 5 to 7. On the left side of the liquid crystal display device 22, a cross key 23, “O” button 24, “X” button 25, an 1 credit-medal bet button 26, a 2 credit-medal bet button 27, and a 3 credit-medal bet button 28 are provided. The cross key 23 senses an operation of 4 directions of up, down, left, and right and is used to select an information item displayed on the liquid crystal display device 22. “O” button 24 is a button to determine the information item selected by the cross key 23, and “X” button 25 is a button to cancel the information item selected by the cross key 23. The credit-medal bet buttons 26 to 28 are used upon betting 1 to 3 medals per one game instead of the insertion of the medal into the medal insertion slot 8 when the medal number is displayed and credited on the credit number display unit 16.

Below the liquid crystal display device 22, a credit-medal payout button 29, a start button 30, and stop buttons 31 to 33 are provided in order from left side. The credit-medal payout button 29 is used to pay out the medals credited in the machine. When the start lever 30 is manipulated by a player, the respective reels 2 to 4 start rotating at the same time. The stop buttons 31 to 33 are arranged corresponding to the respective reels 2 to 4. The operation of the stop button is to be activated when the respective reels 2 to 4 reach a certain rotation speed. In this state, the respective reels 2 to 4 stop rotating according to the player's operation.

A medal tray 37 is provided on the front lower side of the pachi-slot machine 1. The medal tray 37 collects the medals paid out from the medal payout slot 38. A payout display unit 39 is provided on the front upper side of the pachi-slot machine 1 so as to indicate how many medals are paid out for winning, and a pair of speakers 96, 96 is provided on the right/left sides thereof.

In a cabinet of the pachi-slot machine 1, a setting button (not shown) operated when setting a setting value of a ball payout rate and a reset button (not shown) operated when selecting the setting value of the ball payout rate are provided. The setting value of the ball payout rate is a value of the ball payout rate indicative of a ratio of the total number of the medals paid out to a player by a game value offering unit described later to the medals inserted into the machine (i.e., the medals betted per unit game), which value is set to a predetermined area of a control RAM 66. In the present embodiment, the setting value of the ball payout rate displayed on the payout number display unit 20 is varied whenever the setting value is set to “1” or “2” and the reset button is operated once after the operation of the setting button.

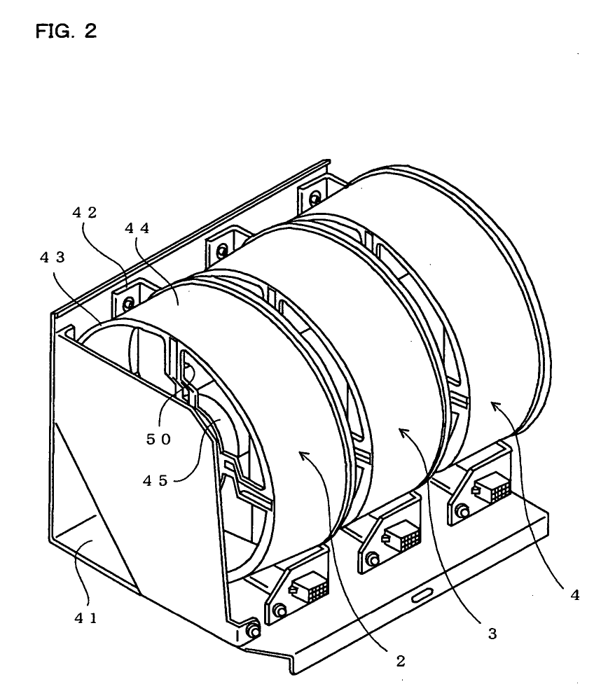

The respective reels 2 to 4 function as the rotating reel unit shown in FIG. 2, and are attached to a frame 41 by means of a bracket 42. The respective reels 2 to 4 are formed by bonding a reel band 44 on the outer periphery of a reel drum 43. The symbol rows are depicted on the outer periphery of the reel band 44. The respective brackets 42 are provided with a stepping motor 45 by which the respective reels 2 to 4 are rotated.

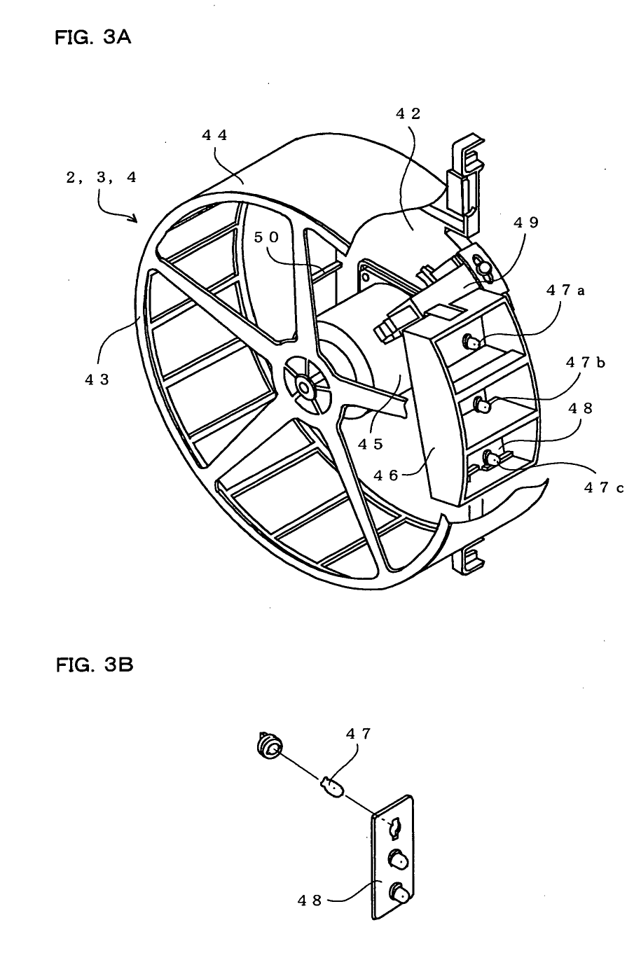

A structure of the respective reels 2 to 4 is illustrated in FIG. 3A. In FIG. 3A, like number refers to like parts and the description thereof will be omitted. As illustrated in FIG. 3A, a lamp case 46 is provided in the reel drum 43 at the back of the reel band 44, and reel back lamps 47a to 47c are attached to three rooms, respectively, of the lamp case 46. These back lamps 47a to 47c are formed with the attachment of the LEDs 47, each emitting different colored light, to a board 48 that is attached to the back side of the lamp case 46. A photo sensor 49 is attached to the bracket 42. The photo sensor 49 detects what a shield plate 50 provided on the reel drum 43 passes through the photo sensor 49 as the reel drum 43 rotates.

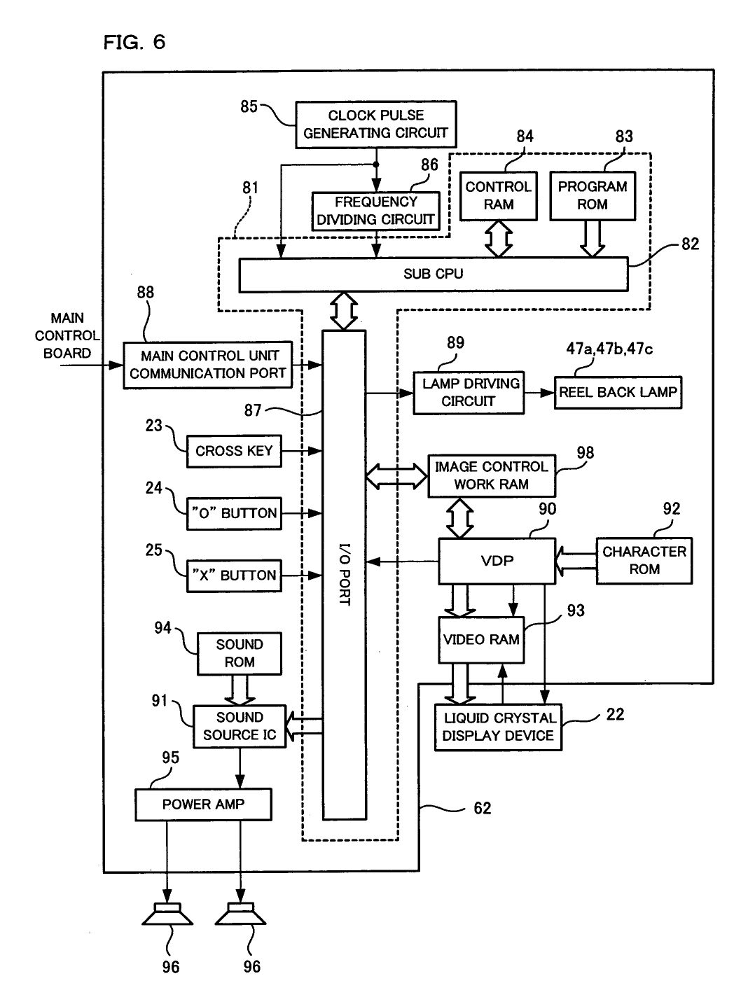

The respective back lamps 47a to 47c are light-controlled by a lamp driving circuit 89 (See FIG. 6) described later. With lighting of the respective back lamps 47a to 47c, three symbols among the depicted symbols in front of the back lamps 47 are individually lightened from the back side so that three symbols come out at the respective display windows 5 to 7.

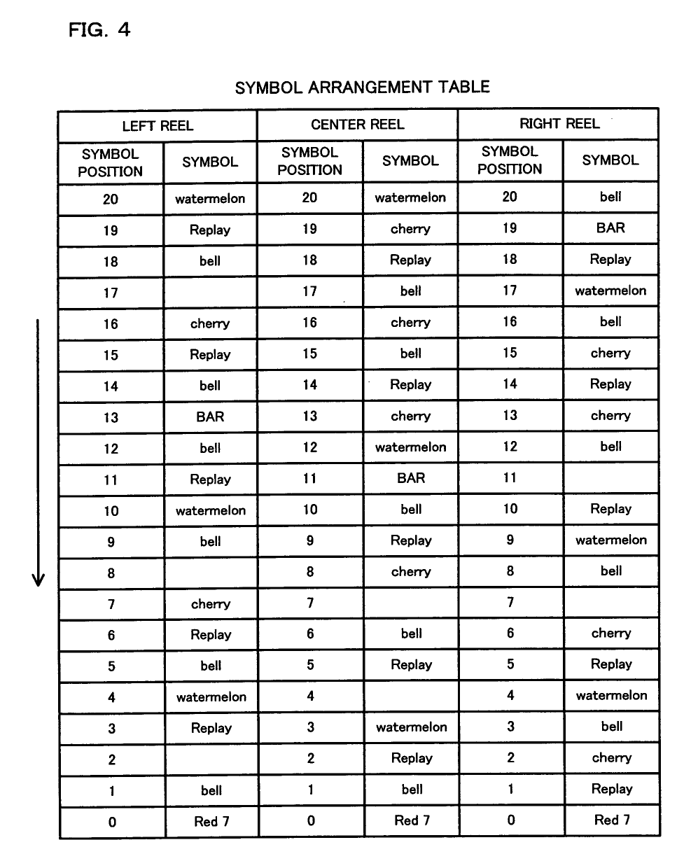

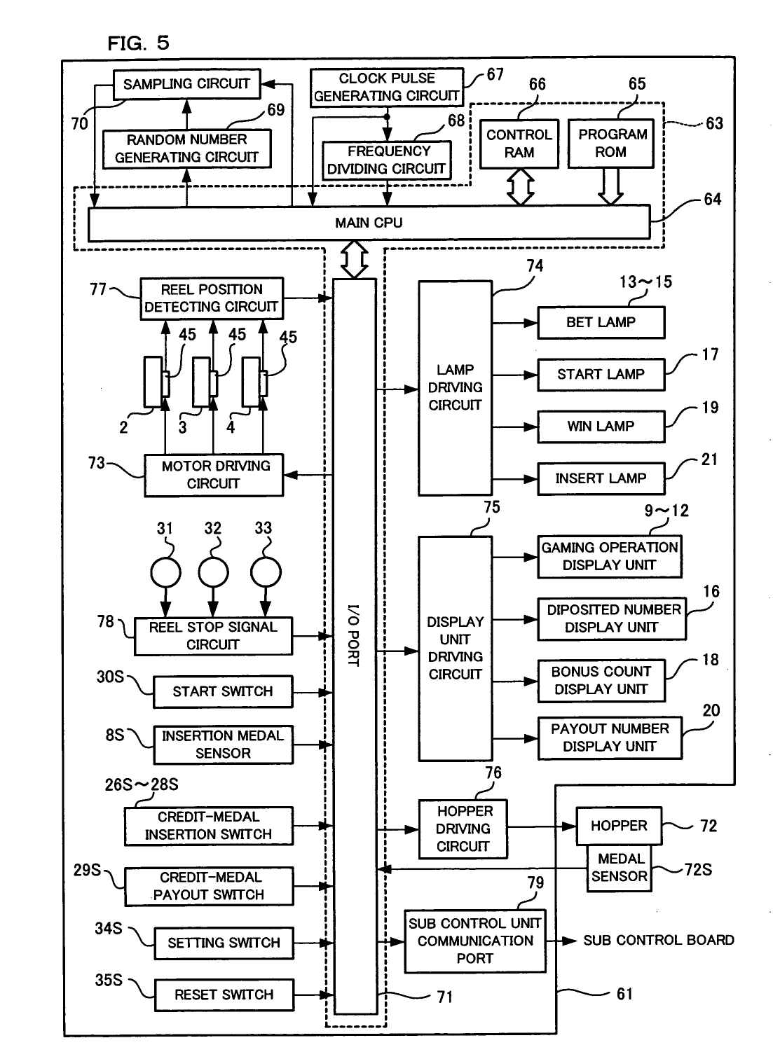

FIG. 4 shows symbol rows in which 21 symbols of the different types depicted on the respective reel bands 44 of the left, center, and right reels 2 to 4 are arranged. The respective symbols are assigned with the code numbers “0” to “20”, respectively, which are stored in a program ROM 65 (See FIG. 5) as a data table. The symbol rows each including symbols of “red 7”, “Replay”, “watermelon”, “bell”, “cherry”, “BAR”, and “blank” are depicted on the respective reels 2 to 4. The respective reels 2 to 4 are rotatably driven such that the symbol rows moves in an arrow direction in the drawing.

A game mode of the pachi-slot machine 1 according to the present embodiment includes “base game mode”, “big bonus (BB) internal winning mode”, “regular bonus (RB) internal winning mode”, and “RB game mode”. These game modes are basically classified into the win types which can be determined as an internal win and the kinds of possible bonus.

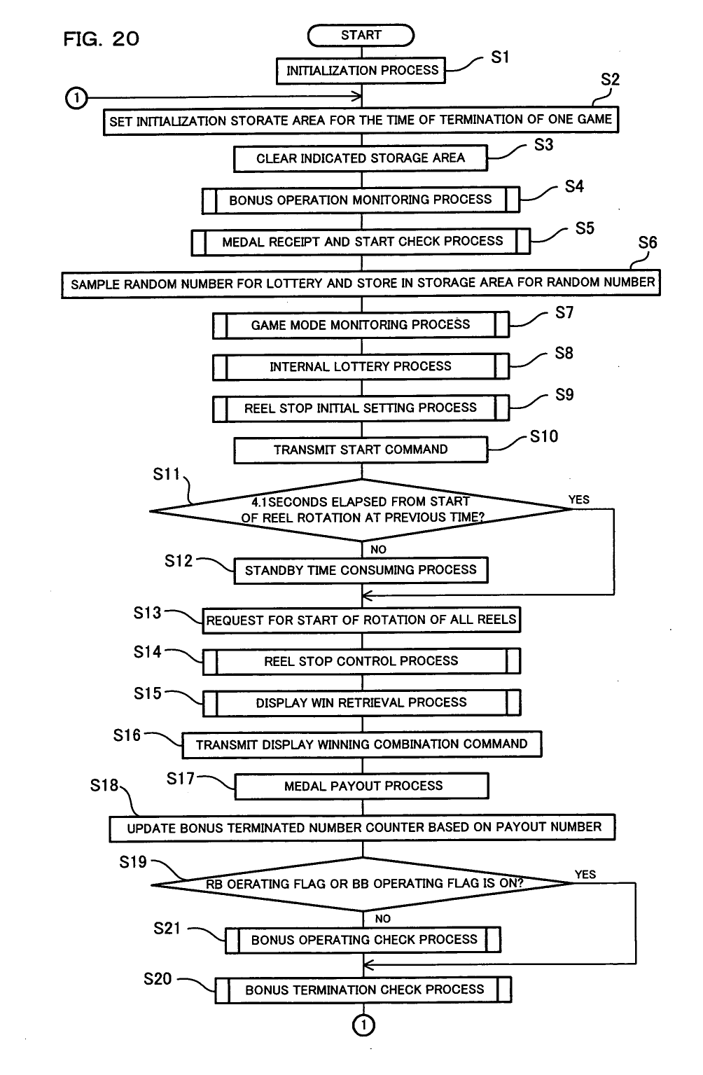

The game mode, which is generated when the combination of the symbols corresponding to BB on an activated line, including “RB game mode” and played with the payout limit of 350 medals is generically called “BB game mode”. “BB internal winning mode” and “RB internal winning mode” are the mode where the game is internally won for the bonus and the combination of the symbols corresponding to the bonus is not yet displayed. These modes are generically called an “internal winning mode”. A bonus winning request flag of “BB” or a winning request flag of “RB” is carried over to a game after the establishment of the flag, and when the symbol combination of “BB” or “RB” is stop-displayed on the activated line and the bonus is actually realized, the bonus winning request flag is cleared. The flag other than the bonus winning request flag is activated to only the game in which the flag is established, and cleared when the game is terminated so that it is not carried over to the next game. Meanwhile, the carryover of the win means that a function as the internal win determined in an internal lottery process (S8 in FIG. 20) can be exerted at the following unit game. It is embodied in various forms. For example, similar to the present embodiment, it may be done that the flag of predetermined internal win is cleared and the carryover continues until the function of the internal win is exerted.

FIGS. 5 and 6 show the circuit construction of a main control board 61 and a sun control board 62 for controlling a gaming process operation of the pachi-slot machine 1.

The control unit of the main control board 61 shown in FIG. 5 includes a microcomputer 63 (referred hereinafter to as microcomputer) as a main element, and an additional circuit for sampling of the random number. The microcomputer 63 includes a main central processing unit (CPU) 64 performing a control operation according to a predetermined program, a program ROM (read only memory) 65 as a program memory, and a control RAM (random access memory) 66 having a backup function.

The main CPU 64 is connected with a clock pulse generating circuit 67 for generating a reference clock pulse and a frequency dividing circuit 68, and a random number generating circuit 69 for generating a random number of a certain range and a sampling circuit 70 for specifying one of the random numbers generated. In addition, an input/output (I/O) port 71 is also connected therewith, through which a signal is communicated with a peripheral device such as an actuator described later.

The program ROM 65 has a separate memory for storing various tables, a sequence program and others. The program ROM 65 stores therein a winning symbol combination table (not shown). In the winning symbol combination table, the symbol codes of the respective winning symbol combinations displayed on the payout display unit 39, the symbol codes of the symbol combination constituting “ready-to-win mode”, the winning determination codes indicative of various winning, and the payout number of the winning medals are stored. Herein, the ready-to-win mode means the symbol combination offering a player suggestions that the combination of the symbols according to the operation of the bonus can be displayed in the internal winning mode. The winning symbol combination table is referred when the reels 2 to 4 are stop-controlled and the display win is retrieved after all the reels stop. In addition, the program ROM 65 stores therein the sequence program for executing a game in the pachi-slot machine 1.

As a main actuator an operation of which is controlled by a control signal from the microcomputer 63, there are a stepping motor 45 for driving the rotation of the reels 2 to 4, various lamps (the BET lamps 13 to 15, the start lamp 17, the WIN lamp 19, and the insert lamp 21), various display units (the gaming operation indicators 9 to 12, the credit number display unit 16, the bonus count display unit 18, and the payout number display unit 20), and a hopper 72 for receiving a medal. These are driven by a motor driving circuit 73, a lamp driving circuit 74, a display unit driving circuit 75, and a hopper driving circuit 76. These driving circuits 73 to 76 are connected with the main CPU 64 via the I/O port 71 of the microcomputer 63.

As a main input signal generating unit for generating an input signal required for the microcomputer 63 to generate a control signal, there are an inserted medal sensor 8S for detecting the medal inserted from the medal insertion slot 8, a start switch 30S for detecting the operation of a start lever 30, the credit-medal insertion switches 26S to 28S for detecting the operation of the credit-medal bet buttons 26 to 28, a credit-medal payout switch 29S for detecting the operation of the credit-medal payout button 29, a setting switch 34S for detecting the operation of a setting button, and a reset switch 35S for detecting the operation of a reset button. The start switch 30S functions as a start operation detector for detecting the start operation of the start lever 30.

In addition, as the input signal generating unit, there is a reel position detecting circuit 77 for detecting a rotation position of the reels 2 to 4 with reception of an output pulse signal from the photo sensor 49. The photo sensor is included in the driving mechanism of the reels 2 to 4, but it is not shown in FIG. 5.

The reel position detecting circuit 77 counts the number of the driving pulses supplied to the stepping motor 45 after the reels 2 to 4 start rotating, and writes the count value to a predetermined area of the control RAM 66. Accordingly, the control RAM 66 stores therein the count value corresponding to the rotation position within a full rotation of the reels 2 to 4. The photo sensor 49 generates a reset pulse at every one rotation of the respective reels 2 to 4. The reset pulse is provided to the main CPU 64 via the reel position detecting circuit 77, and the count value of the driving pulse counted by the control RAM 66 is cleared to “0”. This clearing process clears, at every one rotation, the difference generated between the movement display of the respective symbols and the rotation of the respective stepping motors 45. The stepping motor 45, the motor driving circuit 73, the reel position detecting circuit 77, and the microcomputer 63 functions as a variable display control unit for controlling the symbol display unit to variably display the symbols, based on the detection of the start operation by the start operation detector.

In addition, as the input signal generating unit, there are a reel stop signal circuit 78 for generating a signal to stop the corresponding reel 2 to 4 when the stop button 31 to 33 is pressed, a medal detector 72S for counting the number of the medals paid out from the hopper 72, and a payout completion signal generating circuit (not shown). These are connected with the main CPU 64 via the I/O port 71. The payout completion signal generating circuit generates a signal to detect the completion of the medal payout when the count value of the actually paid-out medals inputted from the medal detector 72S reaches payout number data displayed as the count signal inputted from the display unit driving circuit 75. The reel stop signal circuit 78 functions as a stop operation detector for detecting the stop operation of the stop buttons 31 to 33 by a player. The stepping motor 45, the motor driving circuit 73, the reel position detecting circuit 77, the reel stop signal circuit 78, and the microcomputer 63 functions as a stop control unit for controlling the stop of the variable display controlled by the variable display control unit, based on the detection of the stop operation by the stop operation detector and the internal win determined by an internal win determining unit described later. The microcomputer 63, the hopper 72, the medal detector 72S, the hopper driving circuit 76, and payout completion signal generating circuit are function as the game value offering unit for offering a medal as a game value when a predetermined symbol combination is stop-displayed by the symbol display unit with the result of the stop control by the stop control unit. The setting button, the reset button, the setting switch 34S, the reset switch 35S, and the microcomputer 63 function as a setting value selector for selecting either predetermined 1 or 2 as a ball payout rate indicative of a ratio of the total number of the medals offered to a player by the game value offering unit to the total number of the inserted medals.

The I/O port 71 is connected with a sub control unit communication port 79, and the microcomputer 63 sends a signal to the sub control board 62 via the sub control unit communication port 79. The sub control board 62 shown in FIG. 6 includes therein a main control unit communication port 88 that receives the signal from the microcomputer. The communication between the sub control unit communication port 79 and the main control unit communication port 88 is performed in only one direction from the sub control unit communication port 79 to the main control unit communication port 88. In the present embodiment, the signal transmitted from the sub control unit communication port 79 to the main control unit communication port 88 includes a 7-bit command type indicating a control type thereof and a maximum 24-bit parameter indicating the content of the command.

The sub control board 62 produces a predetermined effect based on a control signal from the main control board 61. The control unit of the sub control board 62 includes a microcomputer 81 as a main element. Similar to the microcomputer 63 of the main control board 61, the microcomputer 81 includes a main CPU 82 performing a control operation according to a predetermined program, a program ROM 83 as a program memory, and a control RAM 84 having a backup function. The sub CPU 82 is also connected with a clock pulse generating circuit 85 for generating a reference clock pulse and a frequency dividing circuit 86, and an I/O port 87 through which a signal is communicated with the main control unit communication port 88 or a peripheral device such as an actuator described later.

As actuator an operation of which is controlled by a control signal from the microcomputer 81, there are reel back lamps 47a to 47c included in the respective reels 2 to 4. Lighting of these back lamps 47a to 47c is controlled by a driving signal from a lamp driving circuit 89 connected to the I/O port 87.

As an input signal generating unit for generating an input signal required for the microcomputer 81 to generate a control signal, there are the cross key 23, “O” button 24, and “X” button 25 described before.

The I/O port 87 is connected with an image control work RAM 98, a video display processor (VDP) 90, and sound source IC 91. The VDP 90 is connected with a character ROM 92 storing character data and a video RAM 93 of a buffer memory for color display, and the image control work RAM 98. The VDP 90 displays an image on the liquid crystal display device 22 under the control of the microcomputer 81.

The sound source IC 91 is connected with a sound ROM 94 storing sound data, and outputs sound from the speaker 96, 96 via a power amp 95 under the control of the microcomputer 81. The microcomputer 81 controls the sound source IC 91 and the power amp 95 according to a command inputted from the main control board 61 via the main control unit communication port 88, and outputs from the speaker 96, 96 an effect sound such as medal insertion sound, start lever operation sound, stop button operation sound, game sound of the bonus game. In addition, it outputs from the speaker 96, 96 sounds in a sound output pattern based on an effect form selected based on the winning flag and the game mode taken from the main control board 61.

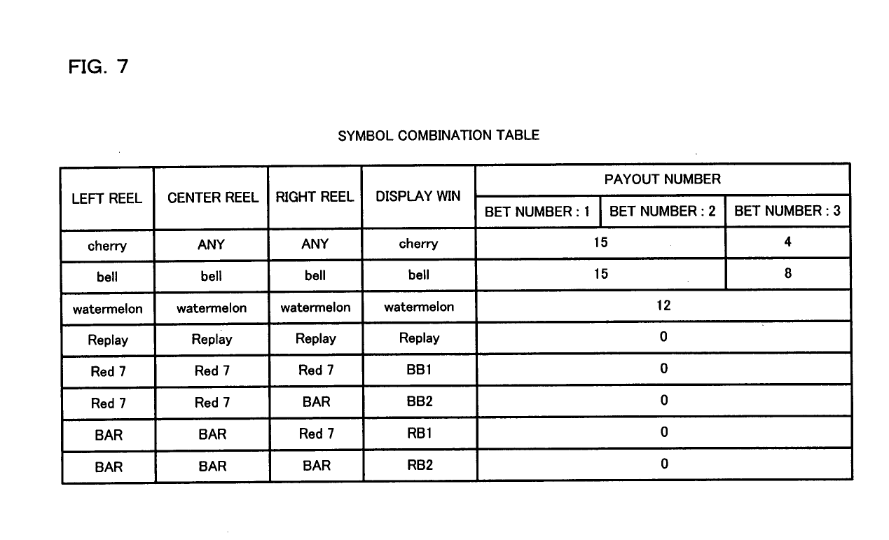

FIGS. 7 to 14 illustrate various tables stored in the program ROM 65 of the main control board 61.

FIG. 7 is a conceptive diagram of a symbol combination table.

The symbol combination table is used to specify a display win and the medal payout number in a step S15 of a main flow chart (See FIG. 20) described later. The symbol combination table stores the relation between the display win and the symbol combination and the medal payout number (i.e., payout) displayed on the activated line with respect to a left reel 2, a center reel 3, and a right reel 4. In FIG. 7, when the combination of the symbols displayed in the fields of the reels 2 to 4 is displayed on the activated line, the number displayed in the field of corresponding payout number and the display win displayed in the field of the display win are specified as the medal payout number and the display win.

As illustrated in FIG. 7, when “cherry-ANY-ANY” is arranged along the activated line, the small win of the “cherry” is specified as a display win, and when the bet number is 1 and 2, and 3, 15 and 4 are respectively specified as the payout number. The “ANY” means any symbol. The bet number means the medal number betted per unit game. When “bell-bell-bell” is arranged along the activated line, the small win of the “bell” is specified as a display win, and when the bet number is 1 and 2, and 3, 15 and 8 are respectively specified as the payout number. When “watermelon-watermelon-watermelon” is arranged along the activated line, the small win of the “watermelon” is specified as a display win, and when the bet number is any one of 1, 2, and 3, 12 is specified as the payout number. When “Replay-Replay-Replay” is arranged along the activated line, the “Replay” is specified as a display win, and 0 medal is specified as the payout number so that the same number of the medals betted in the unit game is automatically betted to the next unit game. When “red 7-red 7-red 7” is arranged along the activated line, “BB1” is specified as a display win, and when the bet number is one of 1 to 3, 0 medal is specified as the payout number so that a BB game mode operates. When “red 7-red 7-BAR” is arranged along the activated line, “BB2” is specified as a display win, and when the bet number is any one of 1 to 3, 0 medal is specified as the payout number so that a BB game mode-operates. When “BAR-BAR-red 7” is arranged along the activated line, “RB1” is specified as a display win, and when the bet number is any one of 1 to 3, 0 medal is specified as the payout number so that an RB game mode operates. When “BAR-BAR-BAR” is arranged along the activated line, “RB2” is specified as a display win, and when the bet number is any one of 1 to 3, 0 medal is specified as the payout number so that an RB game mode operates.

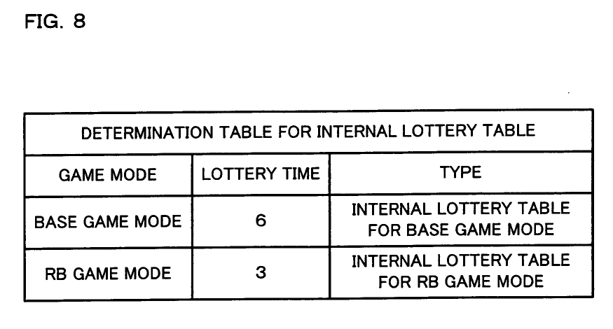

FIG. 8 is a conceptive diagram of a determination table for internal lottery table. The determination table for internal lottery table is used to determine the number of lottery times of the internal win in an internal lottery process (S8 in FIG. 20) described later. In the table, value data indicative of the number of lottery times and the type of an internal lottery table to be used for lottery with respect to each game mode of the base game mode and the RB game mode are assigned. In the internal lottery process described later, the lottery is performed by the number of lottery times indicated by value data, using the internal lottery table corresponding to each game mode. In the base game mode, data indicative of 6 lottery times and an internal lottery table for the base game mode is assigned so that at each unit game during the base game mode, 6 times and the internal lottery table for the base game mode are determined as lottery times and the internal lottery table, respectively. In the RB game mode, data indicative of 3 lottery times and an internal lottery table for RB game mode is assigned so that at each unit game during RB game mode, 3 times and the internal lottery table for RB game mode are determined as lottery times and the internal lottery table to be used for process of the internal lottery, respectively.

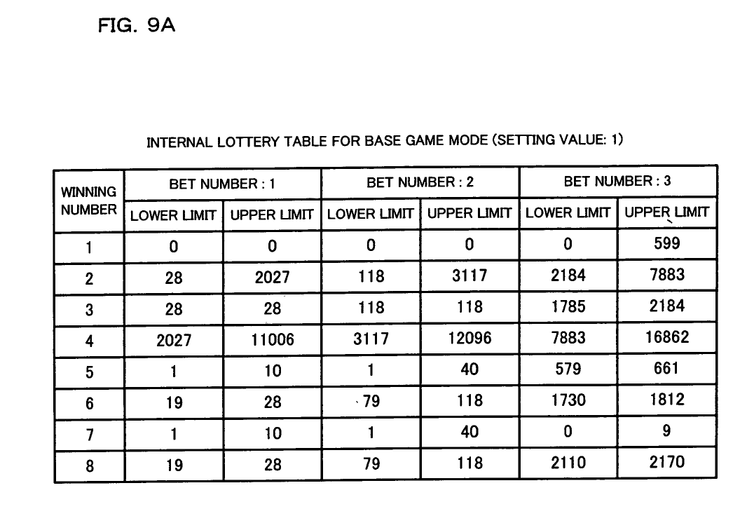

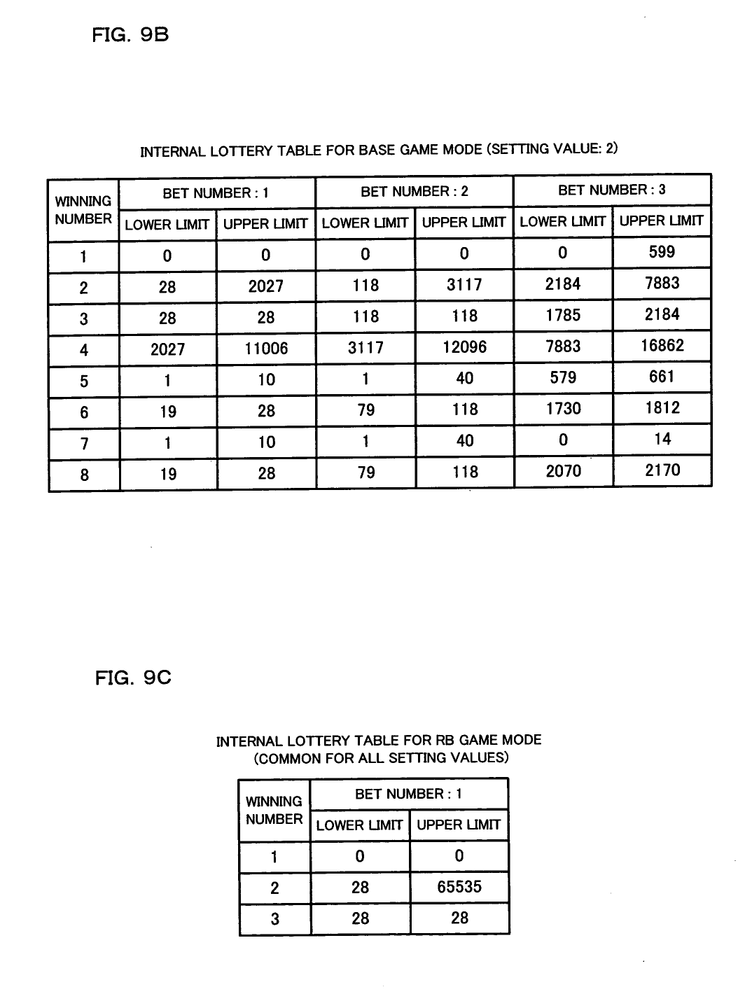

FIGS. 9A to 9C are conceptive diagrams of an internal lottery table. [00511 The internal lottery table is used for lottery of the internal win in the internal lottery process (S8 in FIG. 20) of the main flow chart described later. The internal lottery table stores the upper and lower limits of value data that the random number of a predetermined range “0 to 65535” generated from the random number generating circuit 69 and sampled by the sampling circuit 70 is classified into the winning numbers 1 to 6. The respective winning numbers correspond to the respective internal wins, and value data are stored for each bet number. In the winning numbers 1 to 6, the upper and lower limits defining the respective number ranges in value data of 0 to 65535 are assigned in pair for each game mode, the winning number assigned to the number range to which the sampled random number belongs is selected.

The internal lottery table for the base game mode shown in FIGS. 9A and 9B stores therein value data of the lower and upper limits assigned to each internal win for each setting value of 1 and 2 of the ball payout rate, and is used for the internal lottery process (S8 in FIG. 20) during the base game mode. When the setting value is “1” in the internal lottery table for the base game mode, as illustrated in FIG. 9A, to the winning number 1 corresponding to the small win of the “cherry”, the number range in which the lower limit is 0 and upper limit is 0 is assigned to the bet number of 1 and 2, and the number range in which the lower limit is 0 and the upper limit is 599 is assigned for the bet number of 3. The winning probability for the bet number of 1 and 2 is 1/65536, and the winning probability for the bet number of 3 is 600/65536. To the winning number 2 corresponding to the small win of the “bell”, the number range in which the lower limit is 28 and upper limit is 2027 is assigned for the bet number of 1, the number range in which the lower limit is 118 and upper limit is 3117 is assigned for the bet number of 2, and the number range in which the lower limit is 2184 and the upper limit is 7883 is assigned for the bet number of 3. The winning probability for the bet number of 1 is 2000/65536, the winning probability for the bet number of 2 is 3000/65536, and the winning probability for the bet number of 3 is 5700/65536. To the winning number 3 corresponding to the small win of the “watermelon”, the number range in which the lower limit is 28 and upper limit is 28 is assigned to the bet number of 1, the number range in which the lower limit is 118 and upper limit is 118 is assigned to the bet number of 2, and the number range in which the lower limit is 1785 and the upper limit is 2184 is assigned to the bet number of 3. The winning probability for the bet number of 1 is 1/65536, the winning probability for the bet number of 2 is 1/65536, and the winning probability for the bet number of 3 is 400/65536. To the winning number 4 corresponding to the “Replay”, the number range in which the lower limit is 2027 and upper limit is 11006 is assigned for the bet number of 1, the number range in which the lower limit is 3117 and upper limit is 12096 is assigned for the bet number of 2, and the number range in which the lower limit is 7883 and the upper limit is 16862 is assigned to the bet number of 3. The winning probability for the bet number of one of 1 to 3 is 8980/65536. To the winning number 5 corresponding to the “BB1”, the number range in which the lower limit is 1 and upper limit is 10 is assigned to the bet number of 1, the number range in which the lower limit is 1 and upper limit is 40 is assigned to the bet number of 2, and the number range in which the lower limit is 579 and upper limit is 661 is assigned to the bet number of 3. The winning probability for the bet number of 1 is 10/65536, the winning probability for the bet number of 2 is 40/65536, and the winning probability for the bet number of 3 is 83/65536. To the winning number 6 corresponding to the “BB2”, the number range in which the lower limit is 19 and upper limit is 28 is assigned to the bet number of 1, the number range in which the lower limit is 79 and upper limit is 118 is assigned to the bet number of 2, and the number range in which the lower limit is 1730 and upper limit is 1812 is assigned to the bet number of 3. The winning probability for the bet number of 1 is 10/65536, the winning probability for the bet number of 2 is 40/65536, and the winning probability for the bet number of 3 is 83/65536. To the winning number 7 corresponding to the “RB1”, the number range in which the lower limit is 1 and upper limit is 10 is assigned to the bet number of 1, the number range in which the lower limit is 1 and upper limit is 40 is assigned to the bet number of 2, and the number range in which the lower limit is 0 and the upper limit is 9 is assigned to the bet number of 3. The winning probability for the bet number of 1 is 10/65536, the winning probability for the bet number of 2 is 40/65536, and the winning probability for the bet number of 3 is 10/65536. To the winning number 8 corresponding to the “RB2”, the number range in which the lower limit is 19 and upper limit is 28 is assigned to the bet number of 1, the number range in which the lower limit is 79 and upper limit is 118 is assigned to the bet number of 2, and the number range in which the lower limit is 2110 and the upper limit is 2170 is assigned to the bet number of 3. The winning probability for the bet number of 1 is 10/65536, the winning probability for the bet number of 2 is 40/65536, and the winning probability for the bet number of 3 is 61/65536. When the random number sampled by the sampling circuit 70 is not included in the number range assigned to any of the winning numbers 1 to 6, “Losing” is determined as an internal win.

When the setting value of the ball payout rate is “2” in the internal lottery table for the base game mode, as illustrated in FIG. 9B, even when the bet number is any one of 1 to 3, to the winning number 1 corresponding to the small win of the “cherry”, the winning number 2 corresponding to the small win of the “bell”, the winning number 3 corresponding to the small win of the “watermelon”, the winning number 4 corresponding to the “Replay”, the winning number 5 corresponding to the “BB1”, and the winning number 6 corresponding to the “BB2”, the number range defining the upper and lower limits is assigned as in the case of FIG. 9A where the setting value of the ball payout rate is “1”, and the winning probability is identical to each other. However, regarding the winning number 7 corresponding to the “RB1”, the number range in which the lower limit is 1 and upper limit is 10 is assigned to the bet number of 1, the number range in which the lower limit is 1 and upper limit is 40 is assigned to the, bet number of 2, and the number range in which the lower limit is 0 and the upper limit is 14 is assigned to the bet number of 3. The winning probability for the bet number of 1 is 10/65536, the winning probability for the bet number of 2 is 40/65536, and the winning probability for the bet number of 3 is 15/65536. Regarding the winning number 8 corresponding to the “RB2”, the number range in which the lower limit is 19 and upper limit is 28 is assigned to the bet number of 1, the number range in which the lower limit is 79 and upper limit is 118 is assigned to the bet number of 2, and the number range in which the lower limit is 2070 and the upper limit is 2170 is assigned to the bet number of 3. The winning probability for the bet number of 1 is 10/65536, the winning probability for the bet number of 2 is 40/65536, and the winning probability for the bet number of 3 is 101/65536.

The internal lottery table for the RB game mode shown in FIG. 9C stores therein value data common for all of setting values of 1 and 2, and is used for the internal lottery process (S8 in FIG. 20) during the RB game mode. In the internal lottery table for the RB game mode, regarding the winning number 1 corresponding to the small win of the “cherry”, the number range in which the lower limit is 0 and upper limit is 0 is assigned to the bet number of 1, and when the sampled random number belongs within that number range, the winning number 1 is selected. The winning probability for the winning number 1 is 1/65536. Regarding the winning number 2 corresponding to the small win of the “bell”, the number range in which the lower limit is 28 and upper limit is 65535 is assigned to the bet number of 1, and the winning probability therefor is 65508/65536. Regarding the winning number 3 corresponding to the small win of the “watermelon”, the number range in which the lower limit is 28 and upper limit is 28 is assigned to the bet number of 1, and the winning probability therefor is 1/65536. When the random number sampled by the sampling circuit 70 is not included in the number range assigned to the winning numbers, “Losing” is determined as an internal win. To the winning number 4 corresponding to the “Replay”, the winning number 5 corresponding to the “BB1”, the winning number 6 corresponding to the “BB2”, the winning number 7 corresponding to the “RB1”, and the winning number 8 corresponding to the “RB2”, the number range is not assigned. When the internal lottery table for the RB game mode is used, “Replay”, “BB1”, “BB2”, “RB1”, and “RB2” are not selected as an internal win.

The internal lottery table stored in the program ROM 65 is included in a lottery value defining unit for defining the lower and upper limits of the number range included in predetermined range (0 to 65535) of the random number according to the internal win. The lottery value defining unit performs to make a first number range according to BB1 of the winning number 5 as a first internal win different from a second number range according to RB1 of the winning number 7 as a second internal win that is different from the first internal win, and to make a third number range according to the small win of the cherry of the winning number 1 as a third internal win, which is different from the first and second internal wins, at least partially overlapped with the first and second number ranges, wherein the overlapped ranges of the first and second number ranges with the third number range are different from each other. That is, when the insertion number is 3, in the internal lottery table for the base game mode shown in FIG. 9A, the small win of the cherry corresponding to the winning number 1 is overlapped with the BB1 corresponding to the winning number 5 by the range of 21, i.e., by the number range from 579 to 599, and overlapped with the RB1 corresponding to the winning number 7 by the range of 10, i.e., by the number range of 0 to 9. The lottery value defining unit is performed to make a first number range according to BB2 of the winning number 6 of a first internal win different from a second number range according to RB2 of the winning number 8 of a second internal win that is different from the first internal win, and to make a third number range according to the small win of the watermelon of the winning number 3 of a third internal win, which is different from the first and second internal wins, at least partially overlapped with the first and second number ranges, wherein the overlapped ranges of the first and second number ranges with the third number range are different from each other. That is, when the insertion number is 3, in the internal lottery table for the base game mode shown in FIG. 9A, the small win of the watermelon corresponding to the winning number 3 is overlapped with the BB2 corresponding to the winning number 6 by the range of 28, i.e., by the number range from 1785 to 1812, and overlapped with the RB2 corresponding to the winning number 8 by the range of 61, i.e., by the number range from 2110 to 2170.

In addition, the lottery value defining unit is performed to make the number range according to the RB1 of the winning number 7 of any one of internal wins and the number according to the small win of the cherry of the winning number 1 of other internal win that is different from the one internal win, at least partially overlapped within the range according to the setting value selected by the setting value selector. In addition, the lottery value defining unit is performed to make the number range according to the RB2 of the winning number 8 of any one of internal wins and the number according to the small win of the watermelon of the winning number 3 of other internal win that is different from the one internal win, at least partially overlapped within the range according to the setting value selected by the setting value selector. That is, the RB1 of the winning number 7 and the small win of the cherry of the winning number 1 are overlapped by the number range of 0 to 9 at the setting value of 1, and overlapped by the number range of 0 to 14 at the setting value of 2. The RB2 of the winning number 8 and the small win of the watermelon of the winning number 3 are overlapped by the number range of 2110 to 2170 at the setting value of 1, and overlapped by the number range of 2070 to 2170 at the setting value of 2.

The sampling circuit 70 functions as a random number sampling unit for sampling a random number in a predetermined number range based on the detection of the start operation performed by the start operation detector. The main CPU 64 functions as a random number determining unit for comparing the random number sampled by the random number sampling unit with both the lower and upper limits to determine whether or not the random number sampled by the random number sampling unit is within the number range. When the random number determining unit determines that the random number sampled by the random number sampling unit is within the number range, the main CPU 64 performs as an internal win determining unit for determining an internal win according to that number range.

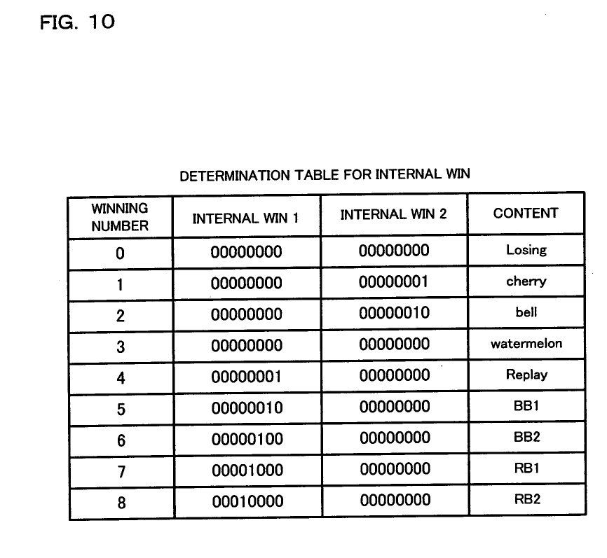

FIG. 10 is a conceptive diagram of a determination table for internal win.

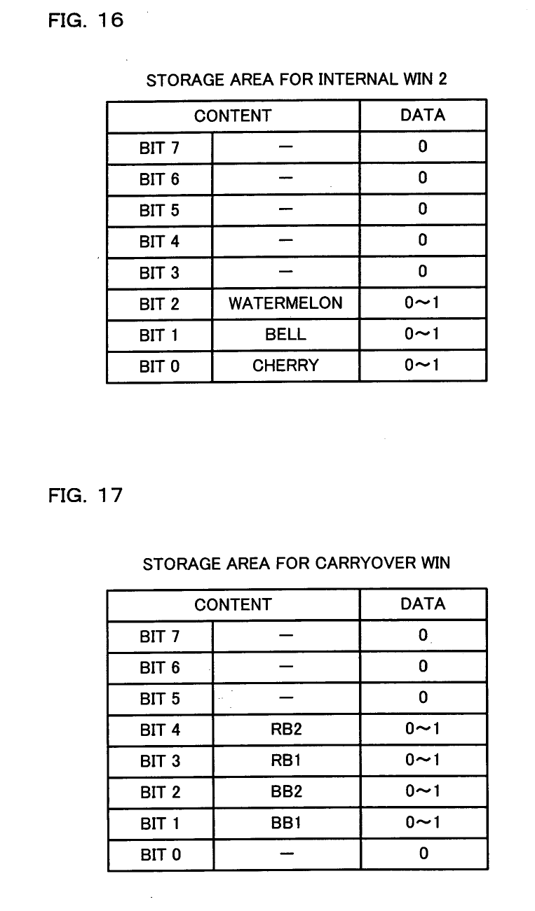

The determination table for internal win is used to determine an internal win in the internal lottery process (S8 in FIG. 20) of the main flow chart described later. The determination table for internal win stores therein the winning numbers 0 to 8 determined using the internal lottery table (See FIGS. 9A to 9C), and 16-bit data corresponding to a winning flag of the internal win. In the determination table for internal win, at the winning number 0, the internal wins 1 and 2 corresponding to “Losing” correspond to “00000000”. At the winning number 1, the internal wins 1 and 2 corresponding to the small win of the “cherry” correspond to “00000000” and “00000001”, respectively. At the winning number 2, the internal wins 1 and 2 corresponding to the “bell” correspond to “00000000” and “00000010”, respectively. At the winning number 3, the internal wins 1 and 2 corresponding to the “watermelon” correspond to “00000000” and “00000100”, respectively. At the winning number 4, the internal wins 1 and 2 corresponding to the “Replay” correspond to “00000001” and “00000000”, respectively. At the winning number 5, the internal wins 1 and 2 corresponding to the “BB1” correspond to “00000010” and “00000000”, respectively. In addition, at the winning number 6, the internal wins 1 and 2 corresponding to the “BB2” correspond to “00000100” and “00000000”, respectively. At the winning number 7, the internal wins 1 and 2 corresponding to the “RB1” correspond to “00001000” and “00000000”, respectively. At the winning number 8, the internal wins 1 and 2 corresponding to the “RB2” correspond to “00010000” and (“00000000”, respectively.

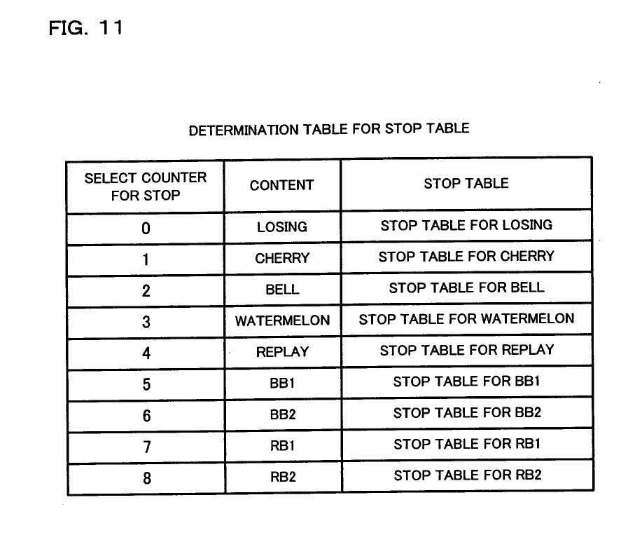

FIG. 11 is a conceptive diagram of a determination table for stop table.

The determination table for stop table is used to determine a stop table to be used for stop control of the left, center, and right reels 2 to 4 in the reel stop initial setting process (S9 in FIG. 20). The determination table for stop table stores therein data corresponding to the respective internal wins, the select counter value for stop, and the stop table to be used for stop control of the reels 2 to 4.

As illustrated in FIG. 11, at the internal win of “Losing”, the select counter value for stop and the stop table correspond to “0” and the stop table for Losing, respectively. The stop table for Losing is a stop table capable of stop-displaying the symbol combination of “Losing”. At the internal win of “cherry”, the select counter value for stop and the stop table correspond to “1” and the stop table for cherry, respectively. The stop table for cherry is a stop table capable of stop-displaying a symbol combination of the small win of the “cherry”. At the internal win “bell”, the select counter value for stop and the stop table correspond to “2” and the stop table for bell, respectively. The stop table for bell is a stop table capable of stop-displaying a symbol combination of the small win of the “bell”. At the internal win “watermelon”, the select counter value for stop and the stop table correspond to “3” and the stop table for cherry, respectively. The stop table for watermelon is a stop table capable of stop-displaying a symbol combination of the small win of the “watermelon”. At the internal win “Replay”, the select counter value for stop and the stop table correspond to “4” and the stop table for Replay, respectively. The stop table for Replay is a stop table capable of stop-displaying a symbol combination of the “Replay”. At the internal win “BB1”, the select counter value for stop and the stop table correspond to “5” and the stop table for BB1, respectively. The stop table for BB1 is a stop table capable of stop-displaying a symbol combination of the “BB1”. At the internal win “BB2”, the select counter value for stop and the stop table correspond to “6” and the stop table for BB2, respectively. The stop table for BB2 is a stop table capable of stop-displaying a symbol combination of the “BB2”. At the internal win “RB1”, the select counter value for stop and the stop table correspond to “7” and the stop table for RB1, respectively. The stop table for RB1 is a stop table capable of stop-displaying a symbol combination of the “RB1”. At the internal win “RB2”, the select counter value for stop and the stop table correspond to “8” and the stop table for RB2, respectively. The stop table for RB2 is a stop table capable of stop-displaying a symbol combination of the “RB2”.

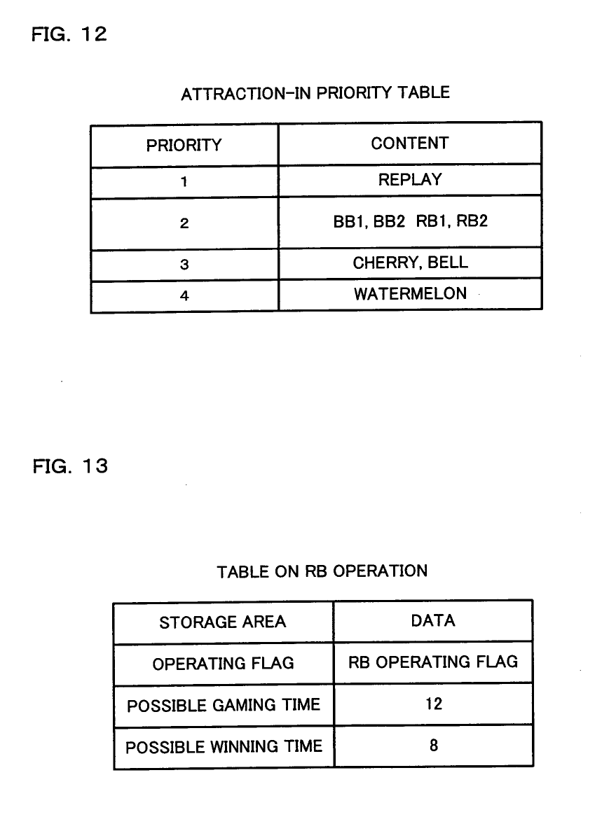

FIG. 12 is a conceptive diagram of an attraction-in priority table.

The attraction-in priority table is used to determine a symbol with priority in the reel stop control process (S14 in FIG. 20) if two ore more international wins are determined in the internal lottery process (S8 in FIG. 20). The attraction-in priority table store therein data corresponding to internal win type and the priority. As illustrated in FIG. 12, the priority 1 corresponds to an internal win “Replay”, the priority 2 corresponds to the internal wins “BB1”, “BB2”, “RB1”, and “RB2”, the priority 3 corresponds to the internal wins “cherry” and “bell”, and the priority 4 corresponds to an internal win “watermelon”. Accordingly, when two or more international wins are determined in the internal lottery process (S8 in FIG. 20), the symbol “Replay” corresponding to the internal win “Replay”, the symbols “red 7” and “BAR” corresponding to the internal wins “BB1”, “BB2”, “RB1”, and “RB2”, the symbols “cherry” and “bell” corresponding to the internal wins “cherry” and “bell”, and the symbol “watermelon” corresponding to the internal win “watermelon” are attracted-in on an activated line in priority.

FIG. 13 is a conceptive diagram of a table on RB operation.

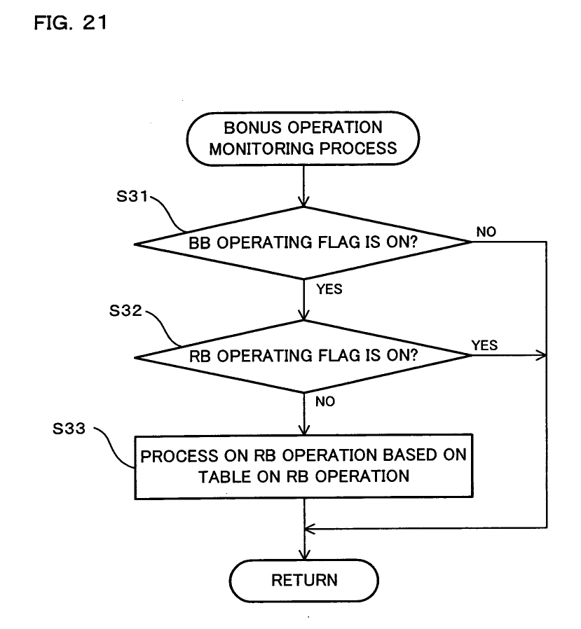

The table on RB operation is used in a bonus operation monitoring process (FIG. 21) described later. The table stores therein data storage area and data stored in the storage area. As illustrated in FIG. 13, in the table, the operation flag storage area corresponds to an RB operating flag indicative of a game mode as data, the storage area for possible gaming times corresponds to the number of the unit games, i.e., 12 times, playable during the RB game, and the storage area for possible winning times corresponds to the number of times, i.e., 8 times, capable of establishing the small win during the RB game as data.

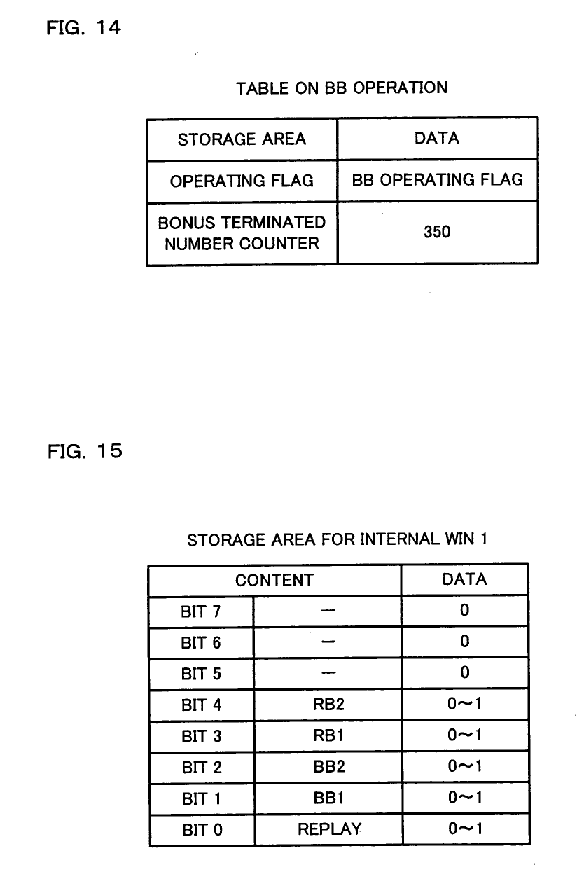

FIG. 14 is a conceptive diagram of a table on BB operation.

The table on BB operation is used in the bonus operation checking process (S21 in FIG. 20) if the display win is BB2 or BB1. The table also stores therein data storage area and data stored in the storage area. As illustrated in FIG. 14, in the table, the storage area for operating flag corresponds to an BB operating flag indicative of a game mode as data, and the storage area for bonus terminated number counter corresponds to the number of the upper limit of the medals, i.e., 350, paid out during the BB game mode as data.

Next, a storage area of the control RAM 66 used in a gaming process executed by the main CPU 64 will be explained with reference to FIGS. 15 to 19.

FIGS. 15 and 16 are conceptive diagrams of the storage areas for internal wins 1 and 2, respectively.

In the storage areas for internal wins 1 and 2, data indicative of the types of the internal wins 1 and 2 determined in the internal lottery process (S8 in FIG. 20) with reference to the determination table for internal win shown in FIG. 20 are stored. As illustrated in FIGS. 15 and 16, the storage areas 1 and 2 for internal wins 1 and 2 are composed of 8 bits of bit 0 to bit 7, each bit set with a value displayed on the data field.

In the storage area for internal win 1 shown in FIG. 15, when the internal win 1 is “00010000” indicative of “RB2”, bits 0 to 3 and bits 5 to 7 of the storage area for internal win 1 are set with a value of “0”, and bit 4 is set with a value of “1”. When the internal win 1 is “00001000” indicative of “RB1”, bits 0 to 2 and bits 4 to 7 of the storage area for internal win 1 are set with a value of “0”, and bit 3 is set with a value of “1”. When the internal win 1 is “00000100” indicative of “BB2”, bit 0, bit 1, and bits 3 to 7 of the storage area for internal win 1 are set with a value of “0”, and bit 2 is set with a value of “1”. When the internal win 1 is “00000010” indicative of “BB1”, bit 0 and bits 2 to 7 of the storage area for internal win 1 are set with a value of “0”, and bit 1 is set with a value of “1”. When the internal win 1 is “00000001” indicative of “Replay”, bits 1 to 7 of the storage area for internal win 1 are set with a value of “0”, and bit 0 is set with a value of “1”.

In the storage area for internal win 2 shown in FIG. 16, when the internal win 2 is “00000100” indicative of “watermelon”, bit 0, bit 1, and bits 3 to 7 of the storage area for internal win 2 are set with a value of “0”, and bit 2 is set with a value of “1”. When the internal win 2 is “00000010” indicative of “bell”, bit 0 and bits 2 to 7 of the storage area for internal win 2 are set with a value of “0”, and bit 1 is set with a value of “1”. When the internal win 2 is “00000001” indicative of “cherry”, bits 1 to 7 of the storage area for internal win 2 are set with a value of “0”, and bit 0 is set with a value of “1”.

FIG. 17 is a conceptive diagram of a storage area for carryover win.

In the storage areas for carryover win, data of a carryover win flag indicative of the types of the carryover win determined in the internal lottery process (S8 in FIG. 20) are stored. As illustrated in FIG. 17, the storage area for carryover win is composed of 8 bits of bit 0 to bit 7, each bit set with a value displayed on the data field.

As illustrated in FIG. 17, when the carryover win flag is “00010000” indicative of “RB2”, bits 0 to 3 and bits 5 to 7 of the storage area for carryover win are set with a value of “0”, and bit 4 is set with a value of “1”. When the carryover win flag is “00001000” indicative of “RB1”, bits 0 to 2 and bits 4 to 7 of the storage area for carryover win are set with a value of “0”, and bit 3 is set with a value of “1”. When the carryover win flag is “00000100” indicative of “BB2”, bit 0, bit 1, and bits 3 to 7 of the storage area for carryover win are set with a value of “0”, and bit 2 is set with a value of “1”. When the carryover win flag is “00000010” indicative of “BB1”, bit 0 and bits 2 to 7 of the storage area for carryover win are set with a value of “0”, and bit 1 is set with a value of “1”. When the carryover win flag is not set, all the bits 0 to 7 of the storage area for carryover win are set with a value of “0”.

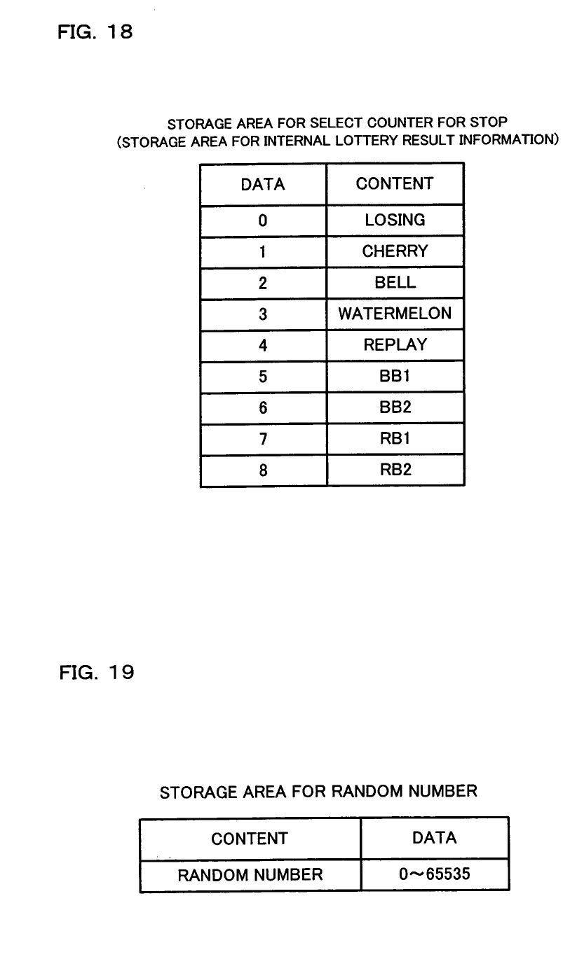

FIG. 18 is a conceptive diagram of a storage area for select counter for stop.

The storage area for select counter for stop stores therein data indicative of a winning number generally determined in the internal lottery process (S8 in FIG. 20) in the reel stop initial setting process (S9 in FIG. 20) as a value of the select counter for stop. When the value of the select counter for stop is the winning number 0 corresponding to “Losing”, the storage area for select counter for stop is set with data indicative of a value of “0”. When the values of the select counter for stop are the winning numbers 1, 2, 3, 4, 5, 6, 7, and 8 corresponding to “cherry”, “bell”, “watermelon”, “Replay”, “BB1”, “BB2”, “RB1”, and “RB2”, respectively, the storage areas for select counter for stop are set with data indicative of the values of “1”, “2”, “3”, “4”, “5”, “6”, “7”, and “8”, respectively.

Further, although a storage area for internal lottery result information has the same construction as the storage area for select counter for stop, the contents of data are not essentially identical to each other. For example, in case of the carryover of BB1 or BB2, the content of data stored in the storage areas for internal lottery result information and select counter for stop, respectively are different from each other.

FIG. 19 is a conceptive diagram of a storage area for value of random number.

The storage area for random number stores therein values of random numbers sampled by the process of S6 in FIG. 20. As illustrated in FIG. 19, the storage area for random number is set with data indicative of any one random number sampled among the numbers 0 to 65535 by the sampling circuit 70.

Next, a control operation of the main CPU 64 of the main control board 61 will be explained with reference to a main flow chart shown in FIG. 20.

First, the main CPU 64 performs an initialization process at the start of a game (SI in FIG. 20). In particular, it performs an initialization of memory of the control RAM 66, an initialization of communication data and others. Then, it performs a setting of initialization storage area for the time of termination of one game (S2).

Next, the main CPU 64 performs a clearing process for an indicated storage area of the control RAM 66 used in the previous game (S3), a bonus operation monitoring process (S4) described later, and a medal receipt and start check process (S5). Then, the main CPU 64 samples a random number for lottery generated by the random number generating circuit 69, using the sampling circuit 70, and stores the sampled random number in the storage area for value of random number (See FIG. 19) (S6). Next, the main CPU 64 performs a game mode monitoring process described later (S7), and an internal lottery process described later (S8).

Next, the main CPU 64 performs a reel stop initial setting process of determining the stop table and so on used in a reel stop control process (S14) for a present unit game, based on the lottery result of the internal lottery process in FIG. 8 (S9). Then, the main CPU 64 transmits a start command to the sub control board 62 via the sub control unit communication port 79 (S10). “Start command” means a command including information of the game mode perceived in S7, the internal win selected in the internal lottery process of S8, and so on.

Then, the main CPU 64 determines whether of a lapse of 4.1 seconds from the start of reel rotation at the previous time (S11). When the determination is “NO”, a standby time consuming process is performed until a lapse of 4.1 seconds (S12). In the standby time consuming process, it is performed a process of invalidating an input based on the player's operation to start a game (herein, a process of making the reels 2 to 4 waiting for the start of rotation).

When 4.1 seconds elapsed from the start of reel rotation at the previous time, the main CPU 64 requests for the start of rotation of all the reels 2 to 4 (S13), starts the rotation of all the reels 2 to 4, and performs a reel stop control process described later (S14). Next, the main CPU 64 performs a display win retrieval process described later (SI5).

Next, the main CPU 64 transmits a “display winning combination command” to the sub control board 62 via the sub control unit communication port 79 (S16). The “display winning combination command” is a command including the types of symbol combinations actually displayed regularly on an activated line. Next, the main CPU 64 performs a medal payout process (S17). In this process, when the game is played with the credited medals, the credited number displayed on the credit number display unit 16 increases by the number of the medals gained by winning, and when the game is played with the medals inserted into the medal insertion slot 8, the medals gained by winning are paid out to the medal tray 37.

After the process of S17, the main CPU 64 updates the bonus terminated number counter based on the payout number of the medals (S18). That is, when the bonus terminated number counter exceeds 1, a subtraction is done for the corresponding counter according to the payout number of the medals. Next, a determination is done on whether a BB operating flag or an RB operating flag is “ON” (S19), and if any one of flags is “ON”, a bonus termination check process described later is done (S20), and if no flag is “ON”, a bonus operation check process described later is done (S21). After the process of S20, the gaming process returns to S2 to start a new unit game.

Next, description will be made to the bonus operation monitoring process performed in S4 in FIG. 20, with reference to FIG. 21.

In the bonus operation monitoring process, the main CPU 64 first performs a determination on whether the BB operating flag is “ON” (S31 in FIG. 21). If the determination is “YES”, the main CPU 64 determines whether the RB operating flag is “ON” (S32). If the determination is “NO”, the main CPU 64 performs a process on RB operation based on the table on RB operation (S33). If the determination of S31 is “NO”, if the determination of S32 is “YES”, or after the process of S3, the bonus operation monitoring process is terminated.

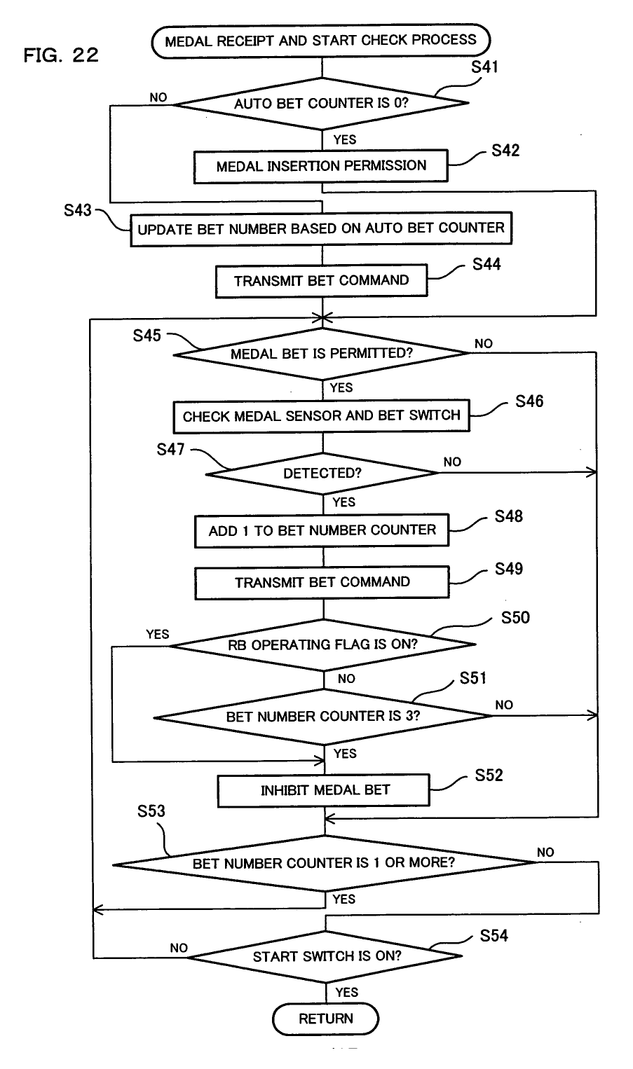

Next, description will be made to the medal receipt and start check process performed in S5 of FIG. 20, with reference to FIG. 22.

In the medal receipt and start check process, the main CPU 64 first determines whether the value of the automatic bet counter is “0”, that is, whether the display win at the previous unit game has not been the “Replay”, and the automatic bet of the medals has not been conducted (S41 of FIG. 22). If the determination is “YES”, the main CPU 64 performs a medal insertion permission process for permitting a medal insertion from the medal insertion slot 8 and the operation of the credit-medal bet buttons 26 to 28 (S42). On the other hand, if the determination is “NO”, the main CPU 64 updates the bet number based on the auto bet counter (S43), and transmits a BET command to the sub control board 62 via the sub control unit communication port 79 (S44). The BET command is a command including information of the number of the medals automatically betted. After the process of S42 or S44, the main CPU 64 determines whether of the permission of the medal insertion, that is, whether the medal insertion from the medal insertion slot 8, or the operation of the credit-medal bet buttons 26 to 28 is permitted (S45), and if the determination is “YES”, the main CPU 64 checks the medal sensor 8S and the credit-medal bet switches 26s to 28S (S46). Then, a determination is done on whether the medal sensor detects the medal insertion, or the credit-medal bet switch 26S to 28S detects the operation of the credit-medal bet button 26 to 28 (S47). If the determination is “YES”, the main CPU 64 adds “1” to the value of the bet number counter (S48). In this process, if the medal inserted from the medal insertion slot 8 is inhibited by the operation of the credit-medal payout button 29, the medal number according to the detected credit-medal bet button 26 to 28 is added to the credited medal number. Then, it transmits a BET command to the sub control board 62 via the sub control unit communication port 79 (S49). The BET command is a command including information of the medal number betted per unit game by the medal inserted from the medal insertion slot 8 or the operation of the credit-medal bet button 26 to 28.

Next, the main CPU 64 determines whether the RB operating flag is ON (S50), and if the determination is “NO”, it determines whether the value of the bet number counter is “3” (S51). If the determination of S50 or S51 is “YES”, the main CPU 64 performs a medal bet inhibition process (S52). In this process, the bet number counter is inhibited from being updated, and if the medal is inserted thereafter, the credited medal number is updated only by the inserted medal number. If the determination of S45, S47, or S51 is “NO”, or after the process of S52, the main CPU 64 determines whether the bet number of the medals, i.e., the medal number betted on the unit game, is 1 or more (S53), and if the determination is “YES”, it determines whether the start switch is ON, that is, whether of input from the start switch 30S based on the operation of the start lever 30 (S54). If the determination of S53 or S54 is “NO”, the process returns to S45 and above processes are repeated. Meanwhile, if the determination is “YES”, the medal receipt and start check process is terminated.

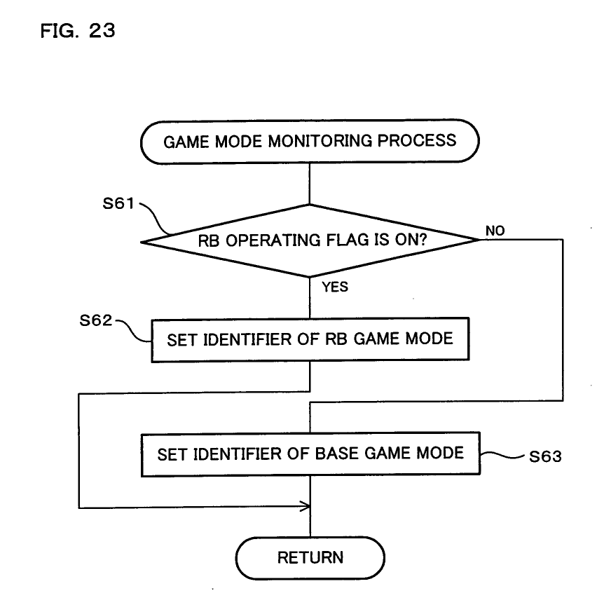

Next, description will be made to the gaming stat monitoring process performed in S7 of FIG. 20, with reference to FIG. 23.

In the game mode monitoring process, the main CPU 64 first performs a determination on whether the RB operating flag is “ON” (S61 of FIG. 23). If the determination is “YES”, the main CPU 64 sets an identifier in RB game mode to a predetermined area of the control RAM 66 (S62), and if the determination is “NO”, it sets an identifier in the base game mode to a predetermined area of the control RAM 66. After the process of S62 or S63 has been done, the game mode monitoring process is terminated.

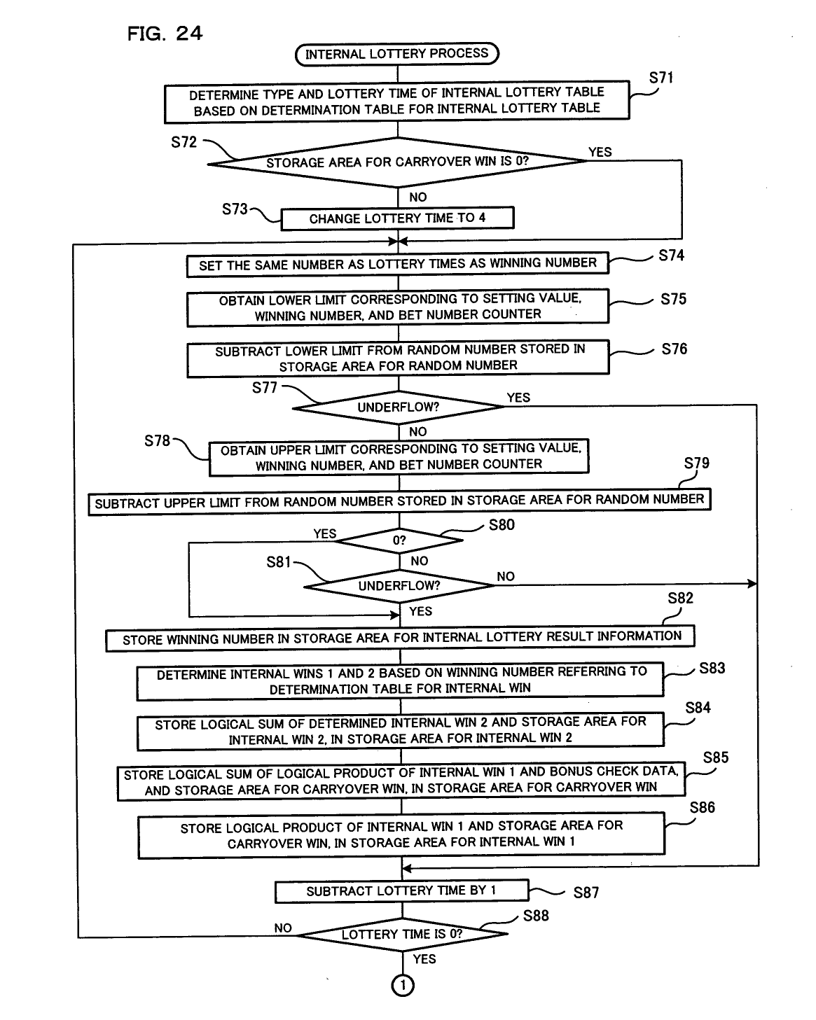

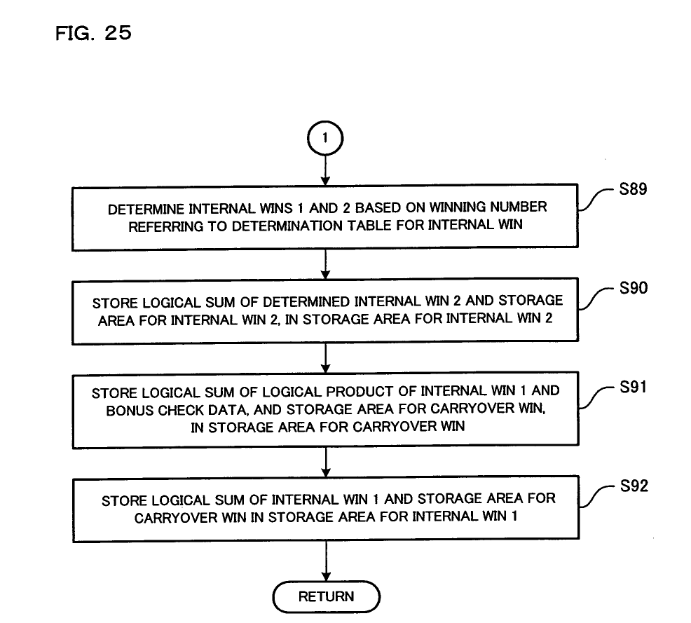

Next, description will be made to the internal lottery process performed in S8 of FIG. 20, with reference to FIGS. 24 and 25.

In the internal lottery process, the main CPU 64 first determines the type of the internal lottery table and the number of lottery times based on the set game mode and with reference to the determination table for internal lottery table (See FIG. 8) (S71 of FIG. 24). Then, the main CPU 64 determines whether the value set to the storage area for carryover win (See FIG. 17) is “0”, that is, whether of no carryover win (S72), and if the determination is “NO”, it changes the number of lottery times to “4” (S73). Next, the main CPU 64 set the same value as the number of lottery times to a register as a winning number (S74). Accordingly, the base game mode is set to “6”, the RB game mode to “3”, and the internal winning mode (the carryover mode) to “4”. Then, it obtains a lower limit L corresponding to the setting value of the ball payout rate, the set winning number, and the value of the bet number counter, with reference to the internal lottery table (See FIGS. 9A to 9C) determined in S71 (S75). Then, a subtraction of the lower limit L is done from the value of the random number R stored in the storage area for the random number of the control RAM 66 (R-L) (S76).

Next, the main CPU 64 determines whether as a result of the subtraction, an underflow is done (S77). If the determination is “NO”, the lower limit is identical to or larger than the random number (L≦R). Next, it is obtained an upper limit U corresponding to the setting value of the ball payout rate, the winning number, and the bet number counter, with reference to the internal lottery table (See FIGS. 9A to 9C) determined in S71 (S78). Then, a subtraction of the upper limit U is done from the random number R stored in the storage area for random number (R-U) (S79).

Next, the main CPU 64 determines whether the subtraction result is “0” (S80). If the determination is “NO”, the random number is not identical to the upper limit and a determination is done on whether as a result of the subtraction, an underflow is done (S81). When the random number equals to the upper limit (R=U) so that the determination of S80 is “YES”, or when the underflow is done, that is, the random number is below the upper limit (R<U), so that the determination of S81 is “YES”, the random number belongs within the number range defined by the lower limit L and the upper limit U (L≦R≦U) so that the main CPU 64 stores the winning number in the storage area for internal lottery result information of the control RAM 66 (S82). Then, it is implemented a determination of internal wins 1 and 2 based on the winning number with reference to the determination table for internal win (See FIG. 10) (S83). Next, the main CPU 64 stores the logical sum of the internal win 2 determined in S83 and the storage area for the internal win (See FIG. 16), in the storage area for the internal win 2 (S84), and establishes the bit on the storage area for the internal win 2 according to the type of the won small win. Then, it is obtained a logical product of the internal win 1 determined in S83 and bonus check data (00000110), and it is performed to store the logical sum of the former logical sum and the storage area for the carryover win (See FIG. 17) in the storage area for the carryover win (S85). The BB2 or BB1 determined accordingly is stored in the storage area for the carryover win. Next, the main CPU 64 stores the logical sum of the internal win 1 and the storage area for the carryover win, in the storage area for the internal win 1 (See FIG. 15) (S86), and establishes the bit in the storage area for the internal win 1 according to the won bonus or Replay.

When the determination of S77 is “YES” and the random number R is below the lower limit L (R<L), when the determination of S81 is “NO” and the random number R is larger than the upper limit U (U<R), or after the process of S86, the main CPU 64 performs a subtraction of the number of lottery times by “1” (S87), and determines whether the number of lottery times is “0” (S88). If the determination is “NO”, the process returns to S74 and the above processes are repeated. Meanwhile, when the determination of S88 is “YES” and the random number R is compared with the lower limit L and the upper limit U for only the number of lottery times, the main CPU 64 determines the internal wins 1 and based on the winning number “0” with reference to the determination table for internal win (S89 in FIG. 25). Then, it stores the logical sum of the determined internal win 2 and the storage area for internal win 2, in the storage area for internal win 2 (S90). As a result, when the random number R does not belong within any number range and S82 to S86 are not performed, basically, the Losing is set to the storage area for internal win 2. Next, the main CPU 64 takes the logical product of the internal win 1 and bonus check data, stores the logical sum of the logical product and the storage area for the carryover win in the storage area for the carryover win (S91), and sets the carryover win of the bonus to the storage area for the carryover win. Next, the main CPU 64 stores the logical sum of the internal win 1 and the storage area for the carryover win in the storage area for the internal win 1 (See FIG. 15) (S92), sets the Losing or the carried over bonus to the storage area for the internal win 1, and terminates the internal lottery process.

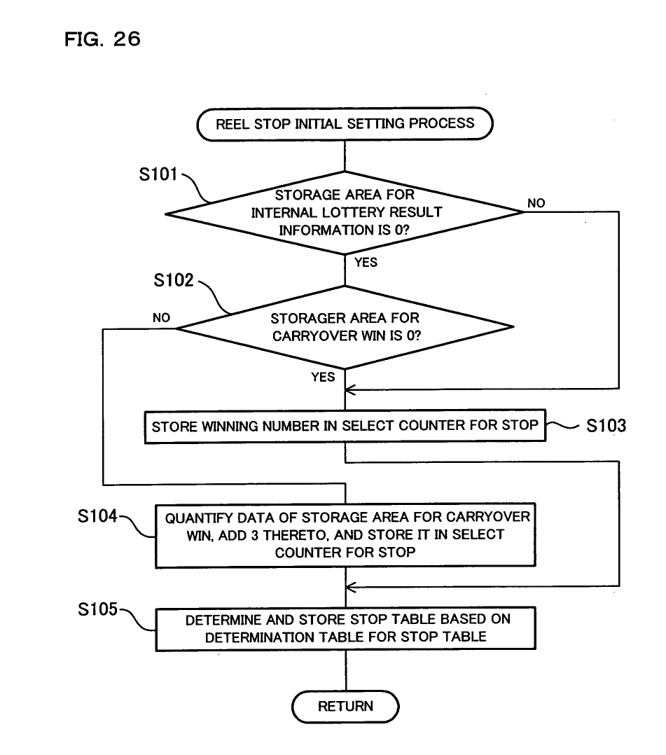

Next, the reel stop initial setting process performed in S9 of FIG. 20 will be explained with reference to FIG. 26.

In the reel stop initial setting process, the main CPU 64 first determines whether the value set to the storage area for internal lottery result information is “0”, that is, whether the internal win is Losing (S101 in FIG. 26). If the determination is “YES”, the main CPU 64 determines whether the value set to the storage area for the carryover win (See FIG. 17) is “0”, that is, whether there is the carried over bonus (S102). When the internal win is not Losing and the determination of S101 is “NO”, or when the internal win is Losing and there is no carried over bonus so that the determination of S102 is “YES”, the main CPU 64 stores the winning number determined in a probability lottery process (S8 in FIG. 20) in the select counter for stop (S103). When the internal win is Losing and there is the carried over bonus so that the determination of S102 is “NO”, the main CPU 64 quantifies data in the storage area and adds “3” thereto, and stores the obtained value in the select counter for stop (Si04). That is, when the bit of the storage area is ON, the main CPU qualifies bits 0, 1, and 2 into 1, 2, and 3, respectively, and adds 3 to the qualified values, and when bit 0, 1, or 3 is ON, the main CPU stores the qualified integers of 4 (Replay), 5 (BB1), and 6 (BB2), respectively, in the select counter for stop. After the process of S103 or S104, the main CPU 64 determines a stop table based on the winning number collected in the select counter for stop with reference to the determination table for stop table (See FIG. 11), stores the determined stop table in a predetermined area of the control RAM 66 (S105), and terminates the reel stop initial setting process.

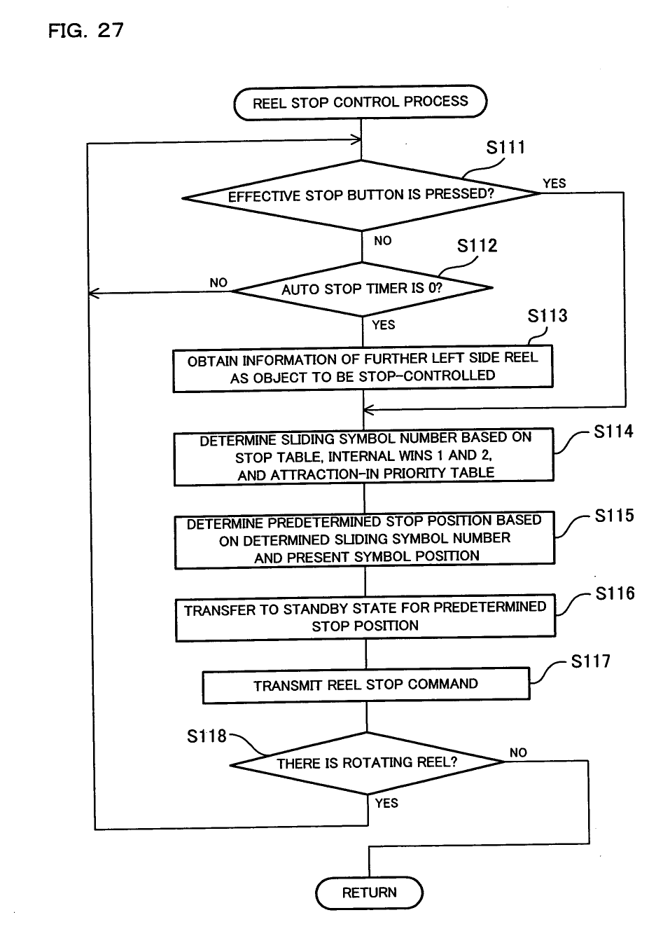

Next, the reel stop control process performed in S14 of FIG. 20 will be explained with reference to FIG. 27.

In the reel stop control process, the main CPU 64 first determines whether the reels 2 to 4 rotates at constant speed and any one stop button 31 to 33 is pressed so that an effective stop switch is “ON” (S111 in FIG. 27). IF the determination is “NO”, the main CPU 64 determines whether the stop button 31 to 33 is not operated and a value of an auto stop timer becomes “0” (S112). If the determination is “NO”, the process returns to S111, and the above processes are repeated. Meanwhile, when the value of the auto stop timer becomes “0” so that the determination of S112 is “YES”, the main CPU 64 obtains information of further left side reels 2 to 4 as an object to be stop-controlled (S113). When the effective stop switch is “ON” so that the determination of Sill is “YES”, or after the process of S113, it subsequently determines the number of sliding symbols based on the stop table determined in the reel stop initial setting process (S9 in FIG. 20), the internal wins 1 and 2 determined in the internal lottery process (S8 in FIG. 20), and the attraction-in priority table (FIG. 12) (S114). Next, the main CPU 64 determines a predetermined symbol stop position based on the number of sliding symbols determined in S114 and a present symbol position (S115), and transfers the process to a standby state for the predetermined stop position waiting for the movement of the symbol to the predetermined stop position determined (S116). Next, the main CPU 64 transmits a reel stop command to the sub control board 62 via the sub control unit communication port 79 (S117), and determines whether there are rotating reels 2 to 4 at present (S118). If the determination is “YES”, the process returns to S111 and the above processes are repeated. Meanwhile, if the determination is “NO”, the stop control process is terminated.

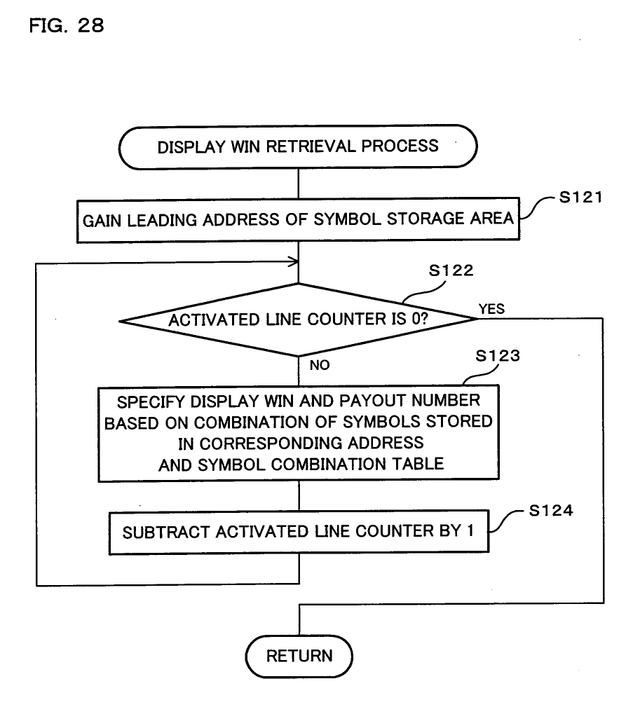

Next, a display win retrieval process performed in S15 of FIG. 20 will be explained with reference to FIG. 28.

In the display win retrieval process, the main CPU 64 obtains a leading address of a symbol storage area (S121 in FIG. 28). The respective addresses of the symbol storage area are set with symbol combinations aligned on the respective pay lines L1, L2A, L2B, L3A, and L3B. Then, the main CPU 64 determines whether the value of an activated line counter is “0” (S122). If the determination is “NO”, it specifies the display win and the payout number based on the symbol combination stored in the corresponding address and the symbol combination table (See FIG. 7) (S123). Then, it subtracts the value of the activated line counter by “1” (S124) and obtains the next address in the symbol storage area. Then, the process returns to S122 and the above processes are repeated to determine whether each activated line is provided with a symbol combination corresponding to a display win. If the determination of S122 becomes “YES”, the display win and the payout number are specified for all the activated lines so that the display win retrieval process is terminated. In the display win retrieval process, when the specified display win is different from the internal win, or when the display win is not included in determination data for display win, an illegal Error is displayed on the payout number display unit 20 and the liquid crystal display device 22.

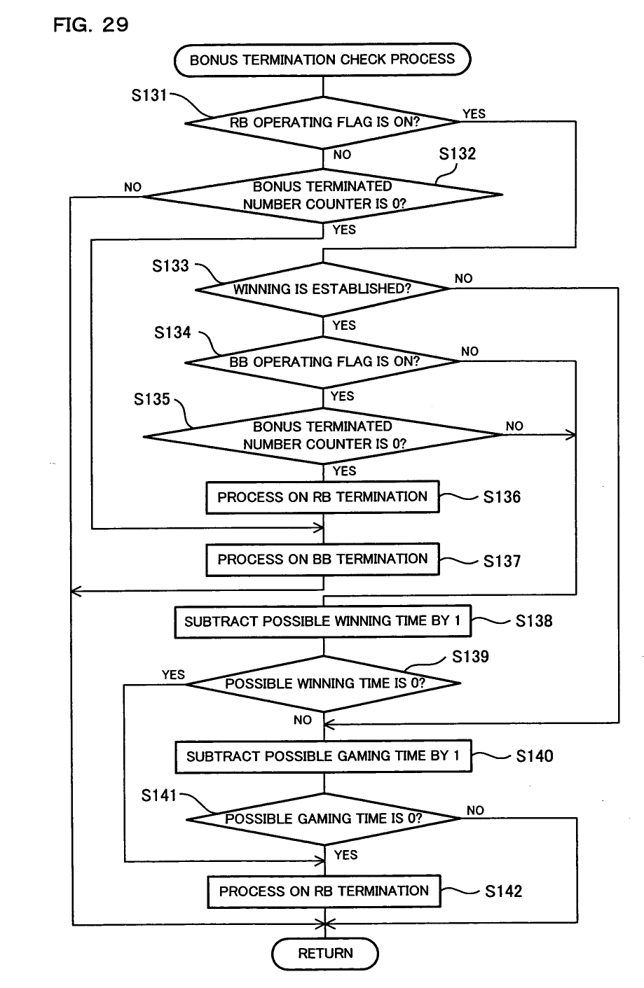

Next, the bonus termination check process performed in S20 in FIG. 20 will be explained with reference to FIG. 29.

In the bonus termination check process, the main CPU 64 first determines whether the RB operating flag is “ON” (SI31 of FIG. 29). If the determination is “NO”, the main CPU 64 determines whether a value of a bonus terminated number counter (See FIG. 14) counting the number of 350 of the medals possibly paid out in the BB game mode is “0” (S132). If the determination is “YES”, the main CPU 64 determines whether the small win is established, that is, whether the display win retrieval process of S15 of FIG. 20 specifies the small win as the display win (S133). If the determination is “YES”, the main CPU 64 determines whether the BB operating flag is ON (S134), and if the determination is “YES”, it determines whether the value of the bonus terminated number counter is “0” (S135). If the determination is “YES”, it performs the process on RB termination for clearing the RB operating flag, or possible winning time and possible gaming time (S136). If the determination of S132 is “YES”, or after the process of S136, the main CPU 64 performs the process on BB termination for clearing the BB operating flag or the bonus terminated number counter (S137).

If the determination of S134 or S135 is “NO”, the main CPU 64 subtracts possible winning time by “1” (S138), and determines whether possible winning time is “0” (S139). If the determination is “NO”, or if the determination of S133 is “NO”, the main CPU 64 subtracts possible gaming time by “1” (S140), and determines whether possible gaming time is “0” (S141). If the determination of S141 or S138 is “YES”, the main CPU 64 performs the process on RB termination (S142). If the determination of S132 or S141 is “NO”, or after the process of S137 or S142, the bonus termination check process is terminated.

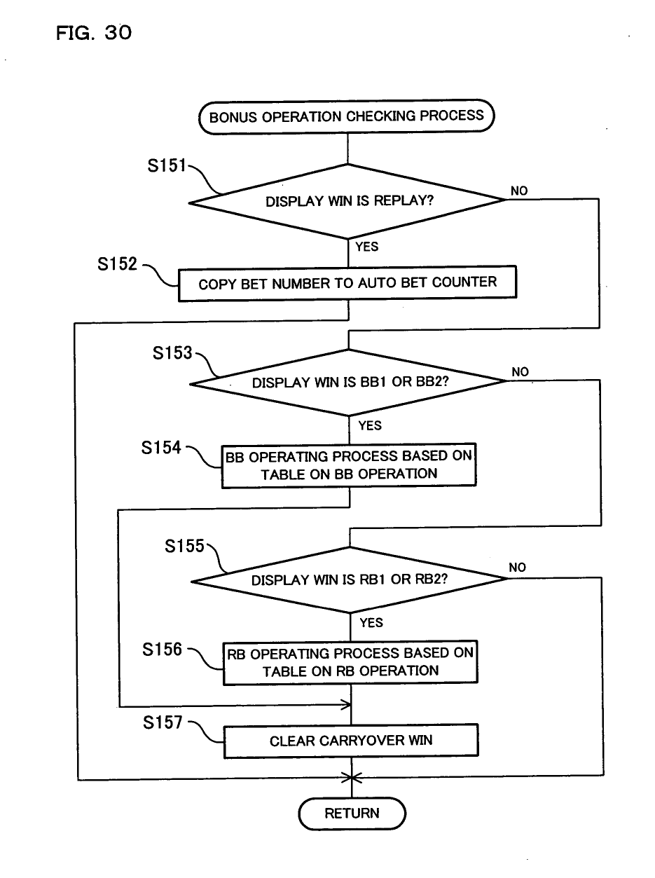

Next, the bonus operation check process performed in S21 of FIG. 20 will be explained with reference to FIG. 30.

In the bonus operation check process, the main CPU 64 first determines whether the display win actually displayed regularly on the reels 2 to 4 is “Replay” (S151 of FIG. 30). If the determination is “YES”, it copies the bet number to the auto bet counter (S152). That is, it sets number data indicative of the same medal number as that of betted on corresponding unit game to the value of the auto bet counter.

If the determination of S151 is “NO”, the main CPU 64 determines whether the display win is “BB1” or “BB2”(S153). If the determination is “YES”, the main CPU 64 performs the process on BB operation based on the table on BB operation (S154). In the process on BB operation, the main CPU 64 sets the BB operating flag and sets 350 to the bonus terminated number counter at the same time. If the determination of S153 is “NO”, the main CPU 64 determines whether the display win is “RB1” or “RB2”(S155). If the determination is “YES”, the main CPU 64 performs the process on RB operation based on the table on RB operation (S156). In the process on RB operation, the main CPU 64 sets the RB operating flag and sets 12 and 8 to the counters for possible gaming time and possible winning time, respectively, at the same time. After the process of S154 or S156, the main CPU 64 clears the carryover win (S157). If the determination of S155 is “NO”, or after the process of S152 or S157, the bonus operation check process is terminated.

In the pachi-slot machine 1 according to the present embodiment, as set forth before, with regard to bet number 3 in the internal lottery table for the base game mode the setting value of which is 1 as shown in FIG. 9A, to the winning number 1 corresponding to the small win of the “cherry”, assigned is a number range where the lower limit is 0 and upper limit is 599, which is partially overlapped with the number range where the lower limit is 579 and upper limit is 661 assigned to the winning number 5 corresponding to “BB1” and the number range where the lower limit is 0 and upper limit is 9 assigned to the winning number 7 corresponding to “RB1”. To the winning number 3 corresponding to the small win of the “watermelon”, assigned is a number range where the lower limit is 1785 and upper limit is 2184, which is partially overlapped with the number range where the lower limit is 1730 and upper limit is 1812 assigned to the winning number 6 corresponding to “BB2” and the number range where the lower limit is 2110 and upper limit is 2170 assigned to the winning number 8 corresponding to “RB2”.

According to the pachi-slot machine 1 of the present embodiment, the third number range according to the small win of the “cherry” of the third internal win is at least partially overlapped with the first and second number ranges according to “BB1” and “RB1” of the first and second internal wins, respectively. In addition, the third number range according to the small win of the “watermelon” of the third internal win is at least partially overlapped with the first and second number ranges according to “BB2” and “RB2” of the first and second internal wins, respectively. Accordingly, when the random number sampled by the random number sampling unit belongs within this overlapped number range, as internal wins according to the respective number ranges, the cherry and the BB1 or RB1, and the watermelon and the BB2 or RB2 are determined at the same time. Therefore, there can be provided a new lottery manner for internal win capable of determining two or more internal wins at one time, using only one random number and one internal lottery table. Moreover, since it does not need to provide lottery tables for each internal win simultaneously determined, there is no need to increase hardware resources such as memory capacity of the program ROM 65. In addition, since the overlapped range “21” between the cherry and the BB1 is different from the overlapped range “10” between the cherry and the RB1, upon the stop display of a symbol combination corresponding to the cherry by the reels 2 to 4, the amount of player's expectation for the determination of the BB1 at the same time, and the amount of player's expectation for the determination of the RB1 can be made different. In addition, since the overlapped range “28” between the watermelon and the BB2 is different from the overlapped range “61” between the watermelon and the RB2, upon the stop display of a symbol combination corresponding to the watermelon by the reels 2 to 4, the amount of player's expectation for the determination of the BB2 at the same time, and the amount of player's expectation for the determination of the RB2 can be made different.

In the pachi-slot machine 1 according to the present embodiment, as set forth before, with regard to the bet number 3 in the internal lottery table for the base game mode the setting value of which is 1 as shown in FIG. 9A, to the winning number 7 corresponding to the “RB1”, assigned is the number range where the lower limit is 0 and upper limit is 9, which is partially overlapped with the number range where the lower limit is 0 and upper limit is 599 assigned to the winning number 1 corresponding to “cherry”. To the winning number 8 corresponding to the “RB2”, assigned is the number range where the lower limit is 2110 and upper limit is 2170, which is partially overlapped with the number where the lower limit is 1785 and upper limit is 2184 assigned to the winning number 3 corresponding to “watermelon”. In case of the bet number 3, in the internal lottery table for the base game mode the setting value of which is 2 as shown in FIG. 9B, to the winning number 7 corresponding to the “RB1”, assigned is the number range where the lower limit is 0 and upper limit is 14, which is partially overlapped with the number range where the lower limit is 0 and upper limit is 599 assigned to the winning number 1 corresponding to “cherry”, and to the winning number 8 corresponding to the “RB2”, assigned is the number range where the lower limit is 2070 and the upper limit is 2170, which is partially overlapped with the number range where the lower limit is 1785 and upper limit is 2184 assigned to the winning number 3 corresponding to “watermelon”. Between the winning numbers 1 and 7, the overlapped range “0 to 9” in case of the setting value 1 is different from the overlapped range “0 to 14” in case of the setting value 2. Between the winning numbers 3 and 8, the overlapped range “2110 to 2170” in case of the setting value 1 is different from the overlapped range “2070 to 2170” in case of the setting value 2.

According to the pachi-slot machine 1 of the present embodiment, since it is defined such that the number range according to the “RB1” of one internal win is at least partially overlapped with the number range according to the small win of the “cherry” of another internal win, if the random number sampled by the random number sampling unit belongs within this overlapped number range, as internal wins according to the respective number ranges, the cherry and the RB1 are determined at the same time. In addition, since it is defined such that the number range according to the “RB2” of one internal win is at least partially overlapped with the number range according to the small win of the “watermelon” of another internal win, if the random number sampled by the random number sampling unit belongs within this overlapped number range, as internal wins according to the respective number ranges, the watermelon and the RB2 are determined at the same time. Therefore, there can be provided a new lottery manner for internal win capable of determining internal wins at one time, using only one random number and one internal lottery table. Moreover, since it does not need to provide lottery tables for each internal win simultaneously determined, there is no need to increase hardware resources such as memory capacity of the program ROM 65. Further, since the overlapped range of the number range according to the RB1 with the number range according to the small win of the cherry is different according to the selected setting value of 1 or 2, the probability of determining the RB1 and the small win of the cherry at the same time is different according to the selected setting value. Accordingly, when the small win of the cherry is determined as an internal win, a player can determine the selected setting value through checking a ratio at which the RB1 is determined at the same time. Further, since the overlapped range of the number range according to the RB2 with the number range according to the small win of the watermelon is different according to the selected setting value of 1 or 2, the probability of determining the RB2 and the small win of the watermelon at the same time is different according to the selected setting value. Accordingly, when the small win of the watermelon is determined as an internal win, a player can determine the selected setting value through checking a ratio at which the RB2 is determined at the same time.

Further, since the number ranges allocated to the respective internal wins have the upper and lower limit values as shown in FIGS. 9A and 9B, they are not necessarily provided in order so that it is possible to irregularly provide the respective number ranges through overlapping or dispersing. Accordingly, it is prevented the sampled random number from continuously belonging within a number range according to an internal win concerning the winning even in the case of repetition of the start operation by the start lever 30 at a certain timing by an unfair practice. Therefore, since there is no case where the internal win concerning the winning is continuously determined in higher probability than predetermined one, it is prevented a game arcade equipped with a gaming machine from being worsened in its business administration.

As a result, there is provided a new lottery manner for an internal win to entertain a player with a new pleasure through defeat of the player's fixed idea as well as to enable to consider an effective counterplan for unfair practice, thereby providing a pachi-slot machine 1 capable of satisfying the request from both a player and a game arcade.

According to the pachi-slot machine of the present embodiment, when the “RB1” or “BB1”, for example, determined as an internal win is carried over, the variable display of the symbols is stop-controlled based also on the carried-over internal win. Accordingly, when it is determined “RB1” and “cherry”, or “BB1” and “cherry” as internal wins, it is prevented a disadvantage that the stop control is performed for the variable display of the symbols according to only “cherry” of one internal win so that a player cannot stop-control the variable display of the symbols according to the “RB1” or “BB1” of the other internal win. In addition, when the“RB2” or “BB2”, for example, determined as an internal win is carried over, the variable display of the symbols is stop-controlled based also on the carried-over internal win. Accordingly, when it is determined “RB2” and “watermelon”, or “BB2” and “watermelon” as internal wins, it is prevented a disadvantage that the stop control is performed for the variable display of the symbols according to only “watermelon” of one internal win so that a player cannot stop-control the variable display of the symbols according to the “RB2” or “BB2” of the other internal win.

Further, according to the pachi-slot machine 1 of the present embodiment, in case of “cherry”, the overlapped number ranges with “BB1” and “RB1” are “21” and “10”, respectively so that the overlapped range with “BB1” is wider. In case of “watermelon”, the overlapped number ranges with “BB2” and “RB2” are “28” and “61”, respectively so that the overlapped range with “RB2” is wider. Accordingly, in the case where one of the small wins of the “cherry” and “watermelon” is a third internal win and the other one is a fourth internal win, when the symbol combination corresponding to “cherry” of the third internal win, for example, is stop-displayed on the reels 2 to 4, it can be raised a player's expectation that a symbol combination corresponding to “BB1” will be provided later so that a BB game mode will operate, while when the symbol combination corresponding to “watermelon” of the fourth internal win is stop-displayed on the reels 2 to 4, it can be raised a player's expectation that a symbol combination corresponding to “RB2” will be provided later so that an RB game mode will operate. As a result, the player's expectations when the symbol combination corresponding to “cherry” is displayed and when the symbol combination corresponding to “watermelon” is displayed, respectively, can be made different from each other. In this case, any internal win can be selected as the third or fourth internal win.

The description of the present embodiment has been made to the case where the number ranges assigned to the small win of the “cherry”, “BB1”, and “RB1” are partially overlapped, the number ranges assigned to the small win of the “watermelon”, “BB2”, and “RB2” are partially overlapped, and the number ranges assigned to the small win of the “watermelon”, “RB1”, and “RB2” are partially overlapped. However, the types of the wins having assigned number ranges which are partially overlapped with each other can be properly changed.

For example, the present invention can be applied assuming that any one of the small wins of the “cherry” and “watermelon” of the third internal win is selected as “Losing”. In this case, in the internal lottery table for base game mode as shown in FIG. 9A, in the first number range according to “BB1” or “BB2” as the first internal win and in the second number range according to “RB1” or “RB2” of the second internal win, the number range not overlapped with the third number range according to the small win of “cherry” or “watermelon” as the third internal win is “600 to 661” or “1730 to 1784” and assigned to “Losing”. The number range assigned to “Losing” is overlapped with that of “BB1” in a range of 62, from 600 to 661, is overlapped with that of “BB2” in a range of 55, from 1730 to 1784, and is not overlapped with the number range according to “RB1” or “RB2”. Accordingly, since the overlapped range “62” or “55” between the “Losing” and “BB1” or “BB2” is different from the overlapped range “0” between the “Losing” and “RB1” or “RB2”, when the symbol combination corresponding to “Losing” is stop-displayed on the reels 2 to 4, the amount of the player's expectation for the simultaneous determination of the “BB1” or “BB2” and the amount of player's expectation for the simultaneous determination of the “RB1” or “RB2” can be made different from each other.

Description is made to the case where the small win of the “watermelon” is a third internal win, and the “Losing” other than “cherry” is a fourth internal win. In case of “watermelon”, the overlapped number ranges between “BB2” and “RB2” are the ranges “28” and “61”, respectively so that the overlapped range with “RB2” is wider, while in case of “Losing”, the overlapped number ranges between “BB1” and “RB1” are the ranges 62 and 0, respectively so that the overlapped range with “BB1” is wider. Accordingly, when the symbol combination corresponding to “watermelon” of the third internal win is stop-displayed on the reels 2 to 4, it can be raised a player's expectation that a symbol combination corresponding to “RB2” will be provided later so that an RB game mode will operate, while when the symbol combination corresponding to “Losing” of the fourth internal win is stop-displayed on the reels 2 to 4, it can be raised a player's expectation that a symbol combination corresponding to “BB1” will be provided later so that a BB game mode will operate. As a result, the player's expectations when the symbol combination corresponding to “watermelon” is displayed and when the symbol combination corresponding to “Losing” is displayed, respectively, can be made different from each other. In this case, any internal win can be selected as the third or fourth internal win.

In the description of the present embodiment, even in the case where in the internal lottery process (S8 in FIG. 20), the random number R is equal to the lower limit L or the upper limit U of the number range (R=L or R=U), the internal win assigned with the number range is determined as an internal win. However, in only case where the random number R exceeds the lower limit L of the number range (L<R), or is below the upper limit (R<U), the internal win assigned with the number range is determined as an internal win, and where the random number R is equal to the lower limit L or the upper limit U (R=L, or R=U), it is determined that the random number R does not belong within the number range and the internal win assigned with the number range may not be determined as an internal win.

In the description of the present embodiment, the number range according to RB1 of the winning number 7 and the number range according to the small win of the cherry of the winning number 1 are partially overlapped with each other in the range according to the setting value, and the number range according to RB2 of the winning number 8 and the number range according to the small win of the watermelon of the winning number 3 are partially overlapped with each other in the range according to the setting value. However, the RB1 can be replaced with BB1 or BB2. Further, the RB2 can be replaced with BB1 or BB2.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
a symbol display unit for displaying a plurality of symbols;
a start operation detector for detecting a start operation by a player;
a random number sampling unit for sampling a random number from a predetermined number range, based on the detection of the start operation performed by the start operation detector;
a lottery value defining unit for defining an upper limit value and a lower limit value of a number range within the predetermined number range in accordance with an internal win;
a random number determining unit for determining whether or not the random number sampled by the random number sampling unit is within the number range, through comparing the value of the random number sampled by the random number sampling unit with both the upper and lower limit values;
an internal win determining unit for determining an internal win according to the number range when the random number determining unit determines that the random number sampled by the random number sampling unit is within the number range;
a variable display control unit for controlling the symbol display unit to variably display the symbols, based on the detection of the start operation by the start operation detector;
a stop operation detector for detecting a stop operation by a player;
a stop control unit for controlling the stop of the variable display controlled by the variable display control unit, based on the detection of the stop operation by the stop operation detector and an internal win determined by the internal win determining unit; and
a game value offering unit for offering a game value when a predetermined symbol combination is displayed in a stop mode by the symbol display unit through the stop control by the stop control unit,
wherein the lottery value defining unit is performed to make a first number range according to a first internal win different from a second number range according to a second internal win that is different from the first internal win, and to make a third number range according to a third internal win, which is different from the first and second internal wins, at least partially overlapped with the first and second number ranges, wherein the overlapped ranges of the first and second number ranges with the third number range are different from each other.

2. A gaming machine comprising:
a symbol display unit for displaying a plurality of symbols;
a start operation detector for detecting a start operation by a player;
a random number sampling unit for sampling a random number from a predetermined number range, based on the detection of the start operation performed by the start operation detector;
a lottery value defining unit for defining an upper limit value and a lower limit value of a number range within the predetermined number range in accordance with an internal win;
a random number determining unit for determining whether or not the random number sampled by the random number sampling unit is within the number range, through comparing the value of the random number sampled by the random number sampling unit with both the upper and lower limit values;
an internal win determining unit for determining an internal win according to the number range when the random number determining unit determines that the random number sampled by the random number sampling unit is within the number range;
a variable display control unit for controlling the symbol display unit to variably display the symbols, based on the detection of the start operation by the start operation detector;
a stop operation detector for detecting a stop operation by a player;
a stop control unit for controlling the stop of the variable display controlled by the variable display control unit, based on the detection of the stop operation by the stop operation detector and an internal win determined by the internal win determining unit;
a game value offering unit for offering a game value when a predetermined symbol combination is displayed in a stop mode by the symbol display unit through the stop control by the stop control unit; and
a setting value selector for selecting a setting value of a ball payout rate indicative of a ratio of total game value offered to a player by the game value offering unit to the total game value to be betted, among a plurality of predetermined values,
wherein the lottery value defining unit is performed to make the number range according to any one of internal wins and the number according to other internal win, which is different from the one internal win, at least partially overlapped within the range according to the setting value selected by the setting value selector.
